(19) United States
(12) Patent Application Publication
(10) Pub. No.: US 2026/0249608 A1
(43) Pub. Date: Aug. 27, 2026

(54) LIQUID EJECTING HEAD AND LIQUID EJECTING APPARATUS

(71) Applicant: SEIKO EPSON CORPORATION, Tokyo (JP)

(72) Inventors: Haruhisa UEZAWA, SHIOJIRI-SHI (JP); Shun KATSUIE, MATSUMOTO-SHI (JP)

(21) Appl. No.: 19/428,718

(22) Filed: Dec. 22, 2025

(30) Foreign Application Priority Data
Dec. 26, 2024 (JP) 2024-230414

(51) Int. Cl. B41J 2/045; B41J 2/14; B41J 2/16

(52) U.S. Cl. CPC B41J 2/0451; B41J 2/04588; B41J 2/04596; B41J 2/14233; B41J 2/161; B41J 2/1623; B41J 2/04581; B41J 2002/14419; B41J 2002/14491; B41J 2202/19

(57) ABSTRACT

A liquid ejecting head includes: a first flow path member that defines a part of a flow path communicating with a plurality of nozzles; a second flow path member that defines a part of the flow path; a first bonding portion that liquid-tightly couples a part of the flow path of the first flow path member and a part of the flow path of the second flow path member; and a second bonding portion that is a bonding portion defining an inner wall of the flow path, the second bonding portion defining a detection space that serves as a space for detecting a degree of deterioration of the first bonding portion and that is partitioned from the flow path.

The present application is based on, and claims priority from JP Application Serial Number 2024-230414, filed Dec. 26, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

In the related art, a liquid ejecting head that ejects liquid such as ink from a nozzle is widely used. For example, JP-A-2023-100338 discloses that a plurality of flow path members constituting a flow path of a liquid ejecting head are joined to each other with an adhesive, thereby liquid-tightly coupling flow paths formed in the plurality of joined flow path members.

The adhesive joining the flow path members deteriorates upon contact with liquid flowing through the flow path, and the liquid in the flow path may leak out from a bonded portion to an outside of the flow path members. However, in the related art mentioned above, there is a problem in that a user of the liquid ejecting head cannot determine when the liquid ejecting head should be replaced.

### SUMMARY

According to a preferred aspect of the present disclosure, there is provided a liquid ejecting head including: a plurality of nozzles that eject liquid; a first flow path member that defines a part of a flow path communicating with the plurality of nozzles; a second flow path member that defines a part of the flow path; a first bonding portion that liquid-tightly couples a part of the flow path of the first flow path member and a part of the flow path of the second flow path member; and a second bonding portion that is a bonding portion defining an inner wall of the flow path, the second bonding portion defining a detection space that serves as a space for detecting a degree of deterioration of the first bonding portion and that is partitioned from the flow path.

According to a preferred aspect of the present disclosure, there is provided a liquid ejecting apparatus including: the liquid ejecting head; an acquisition section that acquires information regarding presence or absence of liquid in the detection space; and an estimation section that estimates the degree of deterioration of the first bonding portion based on the information acquired by the acquisition section.

### BRIEF DESCRIPTION OF THE DRAWINGS

FIG. 1 is a schematic diagram showing a configuration example of an ink jet system according to a first embodiment.

FIG. 2 is a diagram showing a configuration of a processing apparatus.

FIG. 3 is a block diagram showing a configuration example of an ink jet printer.

FIG. 4 is a configuration diagram of the ink jet printer.

FIG. 5 is an exploded perspective view of a liquid ejecting head.

FIG. 6 is a cross-sectional view of the liquid ejecting head taken along line VI-VI in FIG. 5.

FIG. 7 is an enlarged view of a vicinity of an ink hole shown in FIG. 6.

FIG. 8 is a cross-sectional view of a head unit taken along an X-axis direction through a wiring hole.

FIG. 9 is a plan view schematically showing an inside of the head unit.

FIG. 10 is a plan view exemplifying an in-structure flow path.

FIG. 11 is a side view of an in-structure supply flow path and an in-structure discharge flow path.

FIG. 12 is a side view of an in-structure supply flow path and an in-structure discharge flow path.

FIG. 13 is a block diagram showing an example of an electrical configuration of the liquid ejecting head.

FIG. 14 is a timing chart illustrating an operation of the ink jet printer in a recording period.

FIG. 15 is a view illustrating a detection space in the first embodiment.

FIG. 16 is a diagram showing a function of the ink jet system.

FIG. 17 is a diagram showing a flowchart showing an operation of the ink jet system.

FIG. 18 is a block diagram showing a configuration example of an ink jet printer in a second embodiment.

FIG. 19 is a view illustrating a detection space.

FIG. 20 is a view illustrating the detection space.

FIG. 21 is a diagram showing a flowchart showing an operation of an ink jet system in the second embodiment.

FIG. 22 is a block diagram showing a configuration example of an ink jet printer in a third embodiment.

FIG. 23 is a view illustrating a detection space.

FIG. 24 is a diagram showing a flowchart showing an operation of an ink jet system in the third embodiment.

FIG. 25 is a block diagram showing a configuration example of an ink jet printer in a fourth embodiment.

FIG. 26 is a view illustrating a detection space.

FIG. 27 is a diagram showing a flowchart showing an operation of an ink jet system in the fourth embodiment.

FIG. 28 is a block diagram showing a configuration example of an ink jet printer in a fifth embodiment.

FIG. 29 is a view illustrating a detection space.

FIG. 30 is a view illustrating the detection space.

FIG. 31 is a diagram showing a flowchart showing an operation of an ink jet system in the fifth embodiment.

FIG. 32 is a cross-sectional view of a head unit in a first modification example, taken in section.

FIG. 33 is a view illustrating a dummy individual flow path in the first modification example.

### DESCRIPTION OF EMBODIMENTS

Hereinafter, embodiments for implementing the present disclosure will be described with reference to the drawings. Note that, in the drawings, dimensions and scales of each portion are made different from actual ones as appropriate. In addition, since embodiments to be described below are preferred specific examples of the present disclosure, various technically preferable limitations are imposed. However, the scope of the present disclosure is not limited to these embodiments unless there is a description in the following description that particularly limits the present disclosure.

Hereinafter, for convenience of description, one direction along an X-axis from any point will be referred to as an X1 direction, and a direction opposite to the X1 direction will be referred to as an X2 direction. The X1 direction and the X2 direction are collectively referred to as a direction along the X-axis. Similarly, directions opposite to each other along a Y-axis from any point will be referred to as a Y1 direction and a Y2 direction, and directions opposite to each other along a Z-axis from any point will be referred to as a Z1 direction and a Z2 direction. The Y1 direction and the Y2 direction are collectively referred to as a direction along the Y-axis. The Z1 direction and the Z2 direction are collectively referred to as a direction along the Z-axis. The direction along the X-axis and the direction along the Y-axis are orthogonal to each other. The direction along the X-axis and the direction along the Z-axis are orthogonal to each other. The direction along the Y-axis and the direction along the Z-axis are orthogonal to each other. An X-Y plane including the X-axis and the Y-axis corresponds to a horizontal plane. The Z-axis is an axis along a vertical direction, the Z1 direction corresponds to an upper side in the vertical direction, and the Z2 direction corresponds to a lower side in the vertical direction. Additionally, viewing in the direction along the Z-axis may be referred to as “plan view”.

### 1. FIRST EMBODIMENT

### 1-1. Overview of Ink Jet System SYS

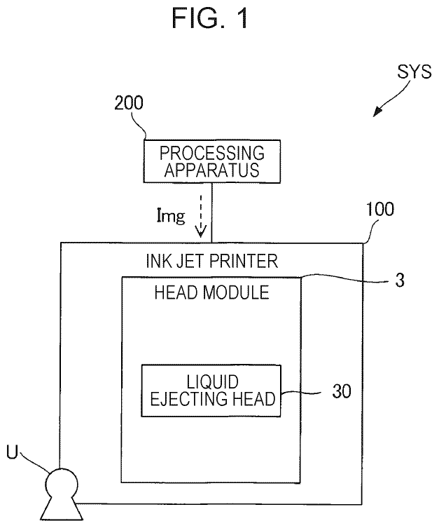

FIG. 1 is a schematic diagram showing a configuration example of an ink jet system SYS according to a first embodiment. The ink jet system SYS is a system that provides a service of forming an image on a medium PP, which will be described below, by using an ink jet method. The ink jet system SYS includes an ink jet printer 100 and a processing apparatus 200.

Here, the ink jet printer 100 is an apparatus provided by a manufacturer of the ink jet printer 100. The ink jet printer 100 is a liquid ejecting apparatus that ejects ink, which is an example of liquid. The manufacturer of the ink jet printer 100 is a company that manufactures the ink jet printer 100. The manufacturer of the ink jet printer 100 may be referred to as a “printer manufacturer”. A liquid ejecting head 30 incorporated into the ink jet printer 100 is provided by a manufacturer of the liquid ejecting head 30. The manufacturer of the liquid ejecting head 30 is a company that manufactures the liquid ejecting head 30. Hereinafter, the manufacturer of the liquid ejecting head 30 may be referred to as a “head manufacturer”. The printer manufacturer receives provision of the liquid ejecting head 30 from the head manufacturer and manufactures the ink jet printer 100 by incorporating the provided liquid ejecting head 30 into the ink jet printer 100. The ink jet printer 100 is an example of a “liquid ejecting apparatus”.

FIG. 1 shows a user U who uses the ink jet printer 100. As the user U, for example, when an operator belonging to the printer manufacturer uses the ink jet printer 100, this operator is the user U. In addition, for example, when a third party who receives the provision of the ink jet printer 100 from the printer manufacturer uses the ink jet printer 100, this third party is the user U. The user U uses the processing apparatus 200 in addition to the ink jet printer 100.

The ink jet printer 100 receives image data Img indicating an image from the processing apparatus 200. The ink jet printer 100 forms an image based on the image data Img on the medium PP. Hereinafter, a process of forming an image on the medium PP may be referred to as a “printing process”.

The ink jet printer 100 includes one head module 3 including one liquid ejecting head 30.

The processing apparatus 200 is a computer such as a desktop type or a notebook type. The processing apparatus 200 may be provided as a part of the ink jet printer 100.

### 1-2. Concerning Failure of Liquid Ejecting Head 30

The liquid ejecting head 30 provided in the ink jet printer 100 may fail because of aging deterioration or the like. One reason for failure of the liquid ejecting head 30 is that a bonding portion that bonds two flow path members constituting a flow path in the liquid ejecting head 30 to liquid-tightly couple flow paths of the two flow path members may come into contact with ink for a long period of time, thereby undergoing either or both of deterioration due to wear caused by a flow velocity or the like and deterioration due to elution of an adhesive into the ink caused by attack by the ink. Consequently, the flow paths of the two flow path members cannot be liquid-tightly coupled, and ink may leak out of the flow path from a location where liquid-tight coupling is no longer possible. Hereinafter, a case where the adhesive can no longer seal a gap between the flow paths of the two flow path members may be referred to as “seal failure”. When seal failure occurs, ink may leak out of the flow path from a location where the seal failure occurs. When ink leaks out of the flow path, the ink may adhere to an electronic circuit in the liquid ejecting head 30 to cause failure, or an inside or a periphery of the ink jet printer 100 may become contaminated with the ink.

Accordingly, there is provided a liquid ejecting head 30 capable of detecting a sign of ink leakage from the liquid ejecting head 30 before the liquid ejecting head 30 fails because of ink leaking out of the flow path from the location where seal failure occurs.

### 1-3. Configuration of Processing Apparatus 200

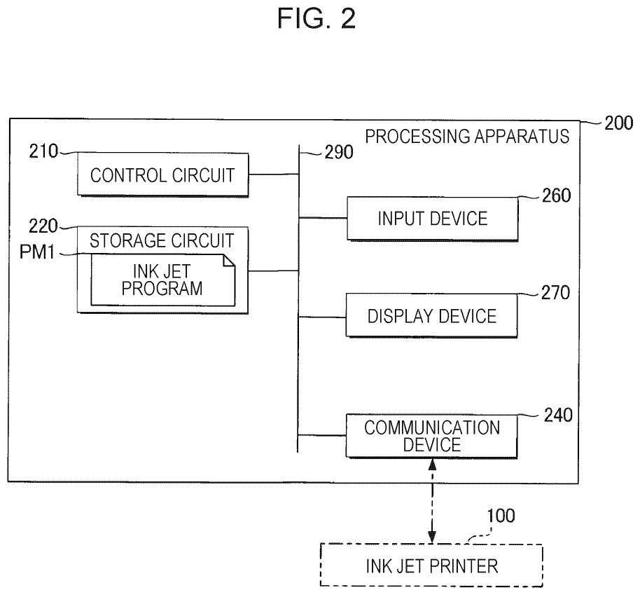

FIG. 2 is a diagram showing a configuration of the processing apparatus 200. The processing apparatus 200 includes a control circuit 210, a storage circuit 220, a communication device 240, an input device 260, and a display device 270. The control circuit 210, the storage circuit 220, the communication device 240, the input device 260, and the display device 270 are mutually connected by a bus 290 for information communication.

The control circuit 210 includes, for example, one or more processors such as a central processing unit (CPU). The control circuit 210 may include a programmable logic device such as a field-programmable gate array (FPGA) instead of the CPU or in addition to the CPU.

The storage circuit 220 is configured with a magnetic storage device, a flash ROM, or the like. The storage circuit 220 is readable by the control circuit 210 and stores a plurality of programs including an ink jet program PM1 executed by the control circuit 210, various kinds of information used by the control circuit 210, and the like. The storage circuit 220 includes, for example, semiconductor memories of one or both of one or more volatile memories, such as a RAM, and one or more non-volatile memories, such as a ROM, an EEPROM, or a PROM. The ink jet program PM1 is, for example, a program for generating the image data Img.

The communication device 240 is a circuit that can communicate with the ink jet printer 100. For example, the communication device 240 is a network card, such as a Universal Serial Bus (USB) or Bluetooth. USB and Bluetooth are registered trademarks.

The input device 260 is a device that outputs operation information corresponding to an operation of the user U. The input device 260 is, for example, a mouse and a keyboard.

The display device 270 displays an image indicating some kind of information to the user U. The display device 270 is an organic electro-luminescence (EL) display, a light emitting diode (LED) display, and a liquid crystal display (LCD). Additionally, the input device 260 and the display device 270 may be configured integrally. A configuration in which the input device 260 and the display device 270 are integral is, for example, a touch panel.

### 1-4. Overview of Ink Jet Printer 100

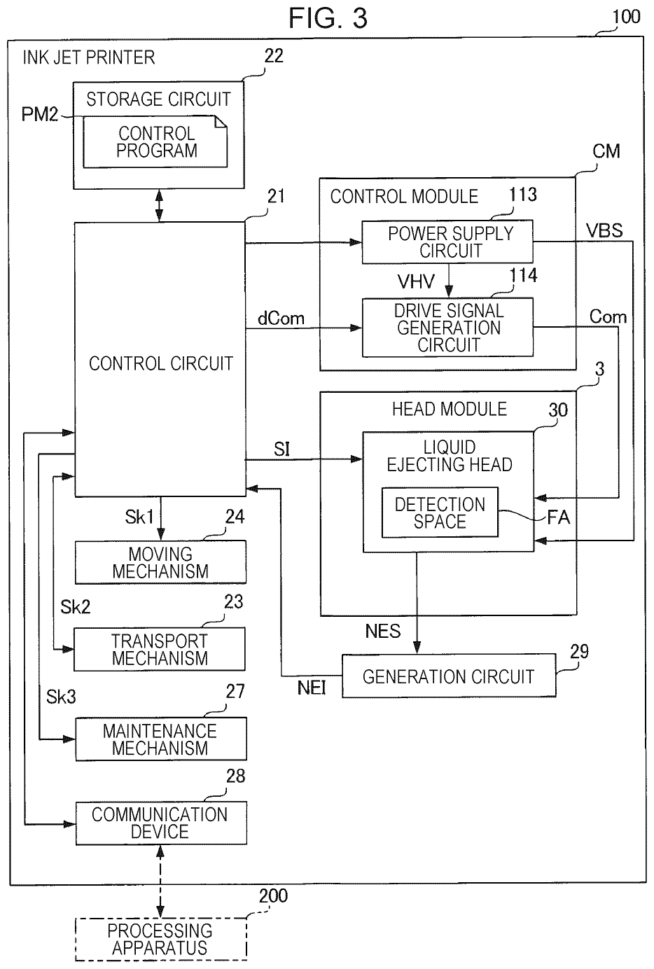

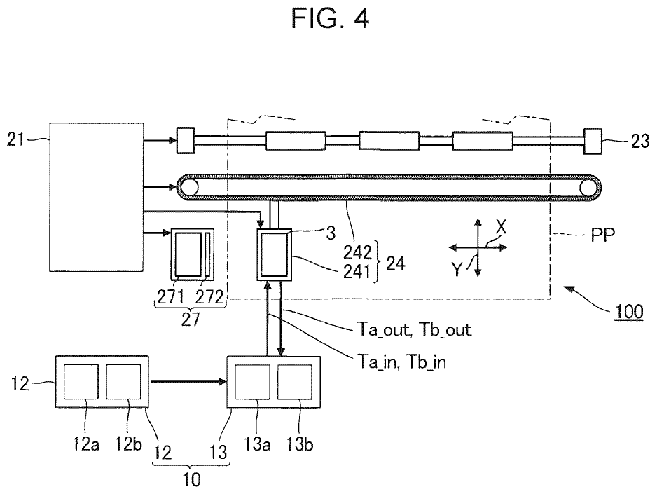

FIG. 3 is a block diagram showing a configuration example of the ink jet printer 100. FIG. 4 is a configuration diagram of the ink jet printer 100. The ink jet printer 100 shown in FIG. 4 is an ink jet type printing apparatus that ejects ink as droplets onto the medium PP. The ink is an example of “liquid”. The medium PP is, for example, printing paper. However, the medium PP is not limited to printing paper and may be, for example, a printing target of any material, such as a resin film or fabric.

As shown in FIGS. 3 and 4, the ink jet printer 100 includes a control module CM, a liquid supply system 10, a control circuit 21, a storage circuit 22, a transport mechanism 23, a moving mechanism 24, the head module 3, a maintenance mechanism 27, a communication device 28, and a generation circuit 29.

The control module CM includes a power supply circuit 113 and a drive signal generation circuit 114. The power supply circuit 113 receives supply of electric power from a commercial power source (not shown) and generates various predetermined potentials. The various generated potentials are supplied to each portion of the ink jet printer 100 as appropriate. In the example shown in FIG. 3, the power supply circuit 113 generates a power supply potential VHV and an offset potential VBS. The offset potential VBS is supplied to the liquid ejecting head 30. Additionally, the power supply potential VHV is supplied to the drive signal generation circuit 114 and the like.

The drive signal generation circuit 114 is a circuit that generates a drive signal Com for driving the liquid ejecting head 30. Specifically, the drive signal generation circuit 114 includes, for example, a DA conversion circuit and an amplification circuit. In the drive signal generation circuit 114, the DA conversion circuit converts a waveform designation signal dCom, which will be described below, from the control circuit 21 from a digital signal into an analog signal, and the amplification circuit generates the drive signal Com by amplifying the analog signal using the power supply potential VHV from the power supply circuit 113.

The liquid supply system 10 includes a liquid container 12 and a sub tank 13. The liquid container 12 stores ink. The sub tank 13 temporarily stores ink supplied from the liquid container 12.

The liquid container 12 includes, for example, a cartridge that is attachable to and detachable from the ink jet printer 100, a bag-shaped ink pack formed of a flexible film, or an ink tank capable of being refilled with ink. The liquid container 12 includes liquid containers 12a and 12b. For example, different color inks are stored in the liquid containers 12a and 12b. A first ink is stored in the liquid container 12a. For example, a second ink having a color different from that of the first ink is stored in the liquid container 12b.

The sub tank 13 includes sub tanks 13a and 13b. The sub tank 13a is coupled to the liquid container 12a and temporarily stores the first ink. The sub tank 13b is coupled to the liquid container 12b and temporarily stores the second ink. In addition, a supply tube Ta_in and a discharge tube Ta_out are coupled to the sub tank 13a. A supply tube Tb_in and a discharge tube Tb_out are coupled to the sub tank 13b. These tubes are coupled to the head module 3. Such a sub tank 13 supplies ink to the head module 3 and collects ink from the head module 3. Accordingly, ink circulates between the sub tank 13 and the head module 3.

The ink is, for example, an aqueous pigment ink, a solvent ink, or an ultraviolet curable ink. The solvent ink is an ink containing an organic solvent. The solvent ink is an ink in which, after being applied to the medium PP, the organic solvent penetrates into the medium PP to form a receiving layer, and a color material is fixed on the receiving layer. The ultraviolet curable ink is an ink containing an ultraviolet curable component. Hereinafter, the ultraviolet curable ink will be referred to as an ultraviolet (UV) ink. The ultraviolet curable component contains a monomer or an oligomer. The UV ink is ink in which, after being applied to the medium PP, the ultraviolet curable component is cured by irradiation with ultraviolet rays, and a color material is fixed in a coating formed by curing of the ultraviolet curable component.

The storage circuit 22 stores various programs including a control program PM2 executed by the control circuit 21 and various kinds of data such as the image data Img processed by the control circuit 21. The storage circuit 22 includes, for example, semiconductor memories of one or both of one or more volatile memories, such as a RAM, and one or more non-volatile memories, such as a ROM, an EEPROM, or a PROM. The storage circuit 22 may be configured as a part of the control circuit 21.

The transport mechanism 23 transports the medium PP along the Y-axis under the control of the control circuit 21. The moving mechanism 24 reciprocates the head module 3 along the X-axis under the control of the control circuit 21.

The moving mechanism 24 includes a substantially box-shaped support 241 that accommodates the head module 3, and an endless belt 242 to which the support 241 is fixed.

The communication device 28 is a circuit that can communicate with the processing apparatus 200. For example, the communication device 28 is a network card, such as USB or Bluetooth. In addition, the communication device 28 may be integrated with the control circuit 21.

The head module 3 ejects ink supplied from the sub tank 13 onto the medium PP under the control of the control circuit 21. By ejecting ink from the head module 3 onto the medium PP in parallel with transport of the medium PP by the transport mechanism 23 and repetitive reciprocation of the support 241, an image is formed on a surface of the medium PP. Ink not ejected from the head module 3 is discharged to the sub tank 13. The head module 3 includes one liquid ejecting head 30, but may include a plurality of liquid ejecting heads 30.

The description returns to FIGS. 3 and 4. The control circuit 21 controls each element provided in the ink jet printer 100. The control circuit 21 includes, for example, one or more of processing circuits, such as a CPU or an FPGA, and one or more of storage circuits, such as a semiconductor memory.

The control circuit 21 controls the operation of each portion of the ink jet printer 100 by executing a program stored in the storage circuit 22. Here, the control circuit 21 generates signals such as a control signal Sk1, a control signal Sk2, a control signal Sk3, a print signal SI, a waveform designation signal dCom, and a request signal RI as signals for controlling the operation of each portion of the ink jet printer 100.

The control signal Sk1 is a signal for controlling driving of the moving mechanism 24. The control signal Sk2 is a signal for controlling driving of the transport mechanism 23. The control signal Sk3 is a signal for controlling the maintenance mechanism 27. The print signal SI is a signal for controlling driving of the liquid ejecting head 30. The waveform designation signal dCom is a digital signal for defining a waveform of the drive signal Com generated by the drive signal generation circuit 114.

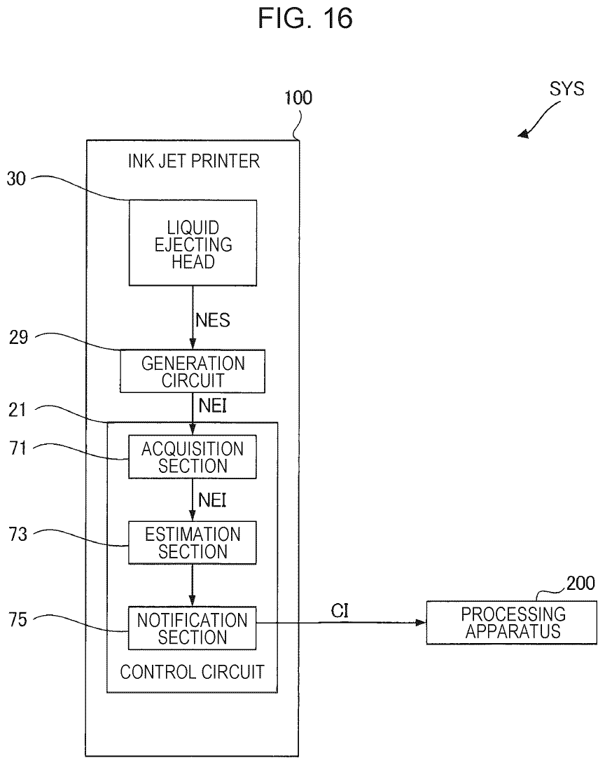

The generation circuit 29 is a circuit that generates residual vibration information NEI that is acquired for purposes such as specifying an ejection abnormality of the liquid ejecting head 30. The generation circuit 29 will be described below with reference to FIG. 16.

The ink jet printer 100 executes a cleaning process for recovering an ejection abnormality of the liquid ejecting head 30 by using the maintenance mechanism 27. The cleaning process includes a flushing process of discharging ink from a nozzle Nz, which will be described below, a wiping process of wiping off foreign matter such as paper dust adhering in the vicinity of the nozzle Nz with a wiper 272, and a pumping process of sucking ink, bubbles, or the like from the nozzle Nz with a tube pump. The flushing process is a process of forcibly removing thickened ink and bubbles mixed into the ink by repeatedly driving a piezoelectric element E, which will be described below, with a drive signal Com for the flushing process. The maintenance mechanism 27 includes a cap 271 for covering the liquid ejecting head 30 such that the nozzle Nz is sealed, the wiper 272, the tube pump (not shown) for sucking ink, bubbles, or the like, and a discharged ink receiving portion (not shown) for receiving ink discharged when ink is discharged. The maintenance mechanism 27 is provided in a region that does not overlap the medium PP when viewed in the Z-axis direction.

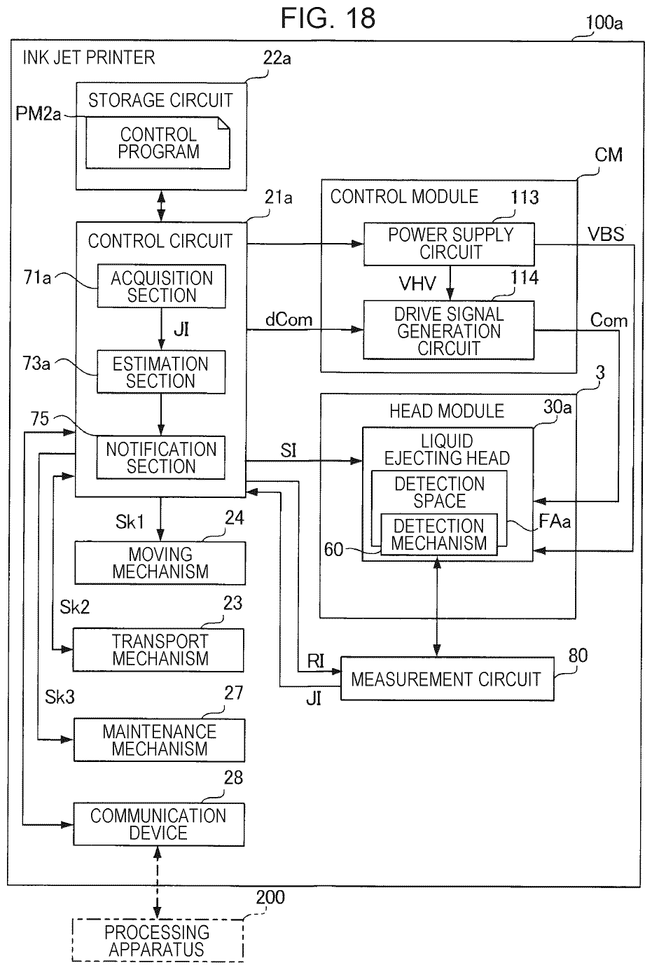

As shown in FIG. 3, the liquid ejecting head 30 is provided with a detection space FA used to detect a sign of ink leakage from the liquid ejecting head 30. The detection space FA will be described below with reference to FIG. 18.

### 1-5. Overall Configuration of Liquid Ejecting Head 30

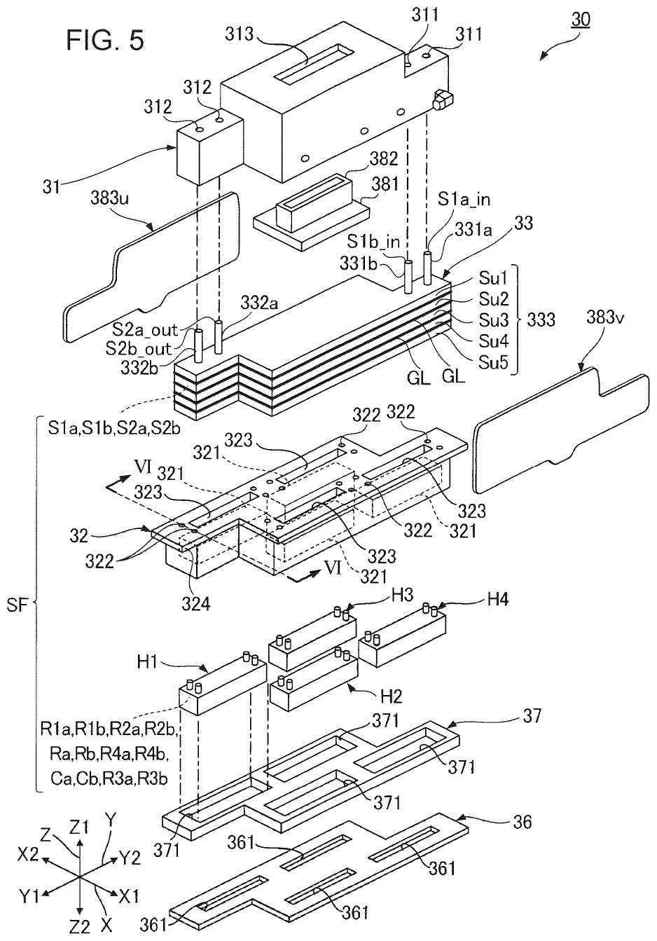

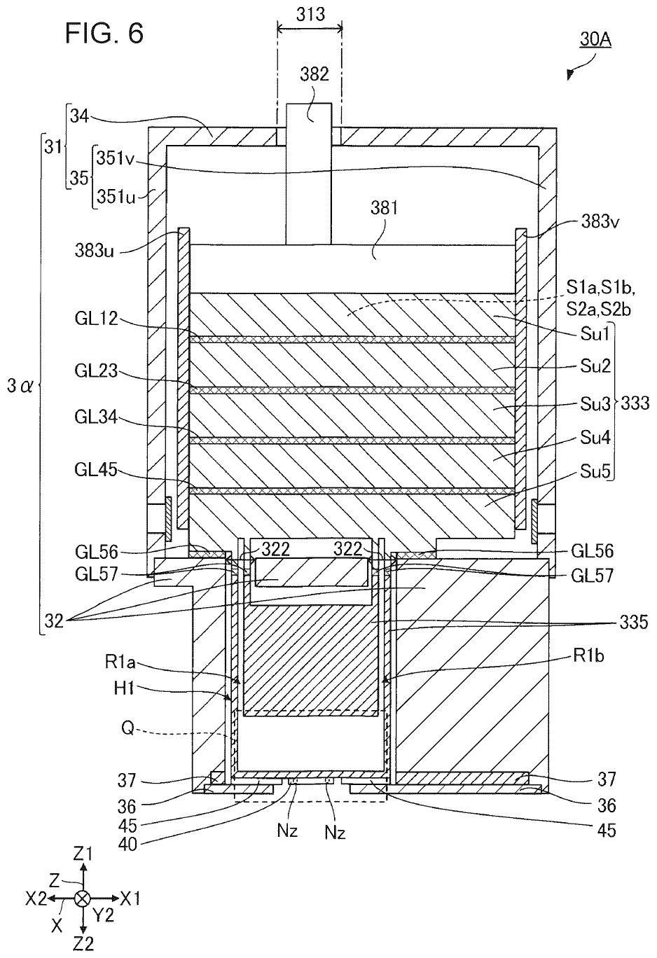

FIG. 5 is an exploded perspective view of the liquid ejecting head 30. FIG. 6 is a cross-sectional view of the liquid ejecting head 30 taken along line VI-VI in FIG. 5. The view shown in FIG. 6 is a view of a cross-section of the liquid ejecting head 30 taken along line VI-VI as viewed in the Y2 direction. The line VI-VI is an imaginary line segment passing through two ink holes 322 and along the X-axis direction.

As shown in FIG. 5, the liquid ejecting head 30 includes a housing 3α, a flow path structure 33, a fixing plate 36, and a reinforcing plate 37. Additionally, the liquid ejecting head 30 includes a plurality of head units H1, H2, H3, and H4. The head units H1, H2, H3, and H4 are referred to as a head unit Hn unless otherwise distinguished. In addition, the liquid ejecting head 30 includes electrical elements such as a wiring substrate 381, a wiring member 382, and circuit boards 383u and 383v. Further, the flow path structure 33 includes a laminate 333, supply coupling portions 331a and 331b, and discharge coupling portions 332a and 332b. Hereinafter, each element provided in the liquid ejecting head 30 will be described with reference to FIGS. 5 and 6.

The housing 3α shown in FIGS. 5 and 6 is a hollow case that accommodates the head unit Hn and the laminate 333. The housing 3α includes a cover member 31 and a holder member 32.

The cover member 31 accommodates the laminate 333. The holder member 32 accommodates the plurality of head units Hn. In the present embodiment, the holder member 32 accommodates four head units Hn. The holder member 32 is disposed in the Z2 direction with respect to the cover member 31.

As shown in FIG. 5, the cover member 31 includes two first coupling portion holes 311, two second coupling portion holes 312, and a first hole 313. The first hole 313 is a hole through which the wiring member 382 is inserted. One of the supply coupling portions 331a and 331b is inserted through and fitted into each first coupling portion hole 311. One of the discharge coupling portions 332a and 332b is inserted through and fitted into each second coupling portion hole 312.

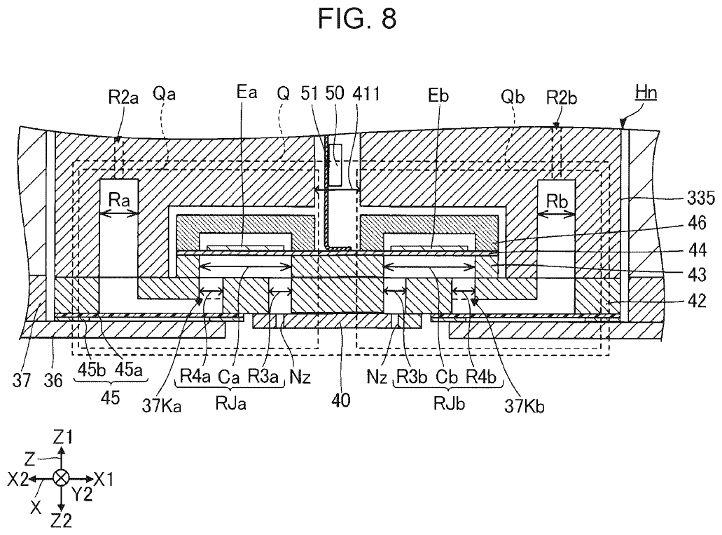

The holder member 32 includes a plurality of recessed portions 321, a plurality of ink holes 322, and a plurality of wiring holes 323. Each recessed portion 321 is a depression that is open in the Z2 direction. The head unit Hn is disposed in each recessed portion 321. Each ink hole 322 is a hole through which ink flows between the flow path structure 33 and the head unit Hn. Each wiring hole 323 communicates with the recessed portion 321. Each wiring hole 323 is a hole through which a flexible substrate 51 shown in FIG. 8 is passed. The flexible substrate 51 is provided for each head unit Hn and is electrically coupled to the head unit Hn. In addition, as shown in FIG. 5, the holder member 32 includes a flange 324 for fixing the holder member 32 to the support 241.

As shown in FIG. 6, the housing 3α includes an upper wall portion 34 and a side wall portion 35. The side wall portion 35 includes a side wall 351u and a side wall 351v.

As shown in FIG. 5, the laminate 333 of the flow path structure 33 includes a plurality of flow path plates Su1, Su2, Su3, Su4, and Su5, and the plurality of flow path plates Su1, Su2, Su3, Su4, and Su5 are referred to as a flow path plate Su unless otherwise distinguished. Each flow path plate Su is formed by, for example, injection molding of a resin, but may also be formed of a metal.

The flow path plates Su1 to Su5 are bonded to each other by an adhesive that forms bonding portions GL12, GL23, GL34, and GL45. The flow path plate Su5 is bonded in the Z1 direction to the holder member 32 by an adhesive that forms a bonding portion GL56. In the following description, a layer formed by an adhesive in the liquid ejecting head 30 is collectively referred to as a bonding portion GL. The bonding portion GL liquid-tightly couples two members. An adhesive forming the bonding portion GL is, for example, an epoxy-based adhesive containing an epoxy resin as a main component, but may also be a silicone-based adhesive or the like.

The liquid ejecting head 30 includes a flow path SF communicating with the nozzle Nz inside. The flow path SF includes in-structure supply flow paths S1a and S1b, in-structure discharge flow paths S2a and S2b, in-head supply flow paths R1a and R1b, in-head discharge flow paths R2a and R2b, a first liquid storage chamber Ra, a second liquid storage chamber Rb, second communication flow paths R4a and R4b, pressure chambers Ca and Cb, and first communication flow paths R3a and R3b. The flow path SF is an example of a “flow path communicating with the nozzle”.

The laminate 333 includes the in-structure supply flow paths S1a and S1b and the in-structure discharge flow paths S2a and S2b. The in-structure supply flow paths S1a and S1b and the in-structure discharge flow paths S2a and S2b are referred to as an in-structure flow path Sn unless otherwise distinguished. Each in-structure flow path Sn is a space formed in the laminate 333. The ink flows through the in-structure flow path Sn. Each in-structure flow path Sn is formed by one or both of grooves along an XY plane provided in each of two flow path plates Su adjacent to each other, and a hole in the flow path plate Su that extends in the Z-axis direction. In FIG. 6, the in-structure flow path Sn is not shown in order to prevent the drawing from being complicated.

Specifically, the in-structure supply flow path S1a supplies the first ink stored in the sub tank 13a to the plurality of head units Hn. The in-structure supply flow path S1b supplies the second ink stored in the sub tank 13b to the plurality of head units Hn. The in-structure discharge flow path S2a discharges the first ink that is not ejected from the plurality of head units Hn to the sub tank 13a. The in-structure discharge flow path S2b discharges the second ink that is not ejected from the plurality of head units Hn to the sub tank 13b. Filter portions Fa and Fb including filters that capture foreign matter or bubbles mixed into ink may be installed in the in-structure flow paths Sn.

Each of the supply coupling portions 331a and 331b and the discharge coupling portions 332a and 332b is provided in the Z1 direction with respect to the laminate 333 and protrudes from the laminate 333 in the Z1 direction. Each of the supply coupling portions 331a and 331b and the discharge coupling portions 332a and 332b is a coupling tube for communication between each in-structure flow path Sn and the outside of the housing 3α.

Specifically, the supply coupling portion 331a is a supply tube through which the first ink is supplied from the sub tank 13a to the in-structure supply flow path S1a, and is provided with a supply port S1a_in for supplying the first ink to the laminate 333. The supply coupling portion 331b is a supply tube through which the second ink is supplied from the sub tank 13b to the in-structure supply flow path S1b, and is provided with a supply port S1b_in for supplying the second ink to the laminate 333. The discharge coupling portion 332a is a discharge tube through which the first ink is discharged from the in-structure discharge flow path S2a to the sub tank 13a, and is provided with a discharge port S2a_out for discharging the first ink from the laminate 333. The discharge coupling portion 332b is a discharge tube through which the second ink is discharged from the in-structure discharge flow path S2b to the sub tank 13b, and is provided with a discharge port S2b_out for discharging the second ink from the laminate 333.

The head unit Hn includes the in-head supply flow paths R1a and R1b, the in-head discharge flow paths R2a and R2b, and a liquid ejecting portion Q that ejects ink. The first liquid storage chamber Ra, the second liquid storage chamber Rb, the second communication flow paths R4a and R4b, the pressure chambers Ca and Cb, and the first communication flow paths R3a and R3b are provided in the liquid ejecting portion Q. The flow paths provided in the liquid ejecting portion Q are shown in FIG. 8.

In FIG. 6, the detailed shape of the liquid ejecting portion Q is not shown in order to prevent the drawing from being complicated. The detailed shape of the liquid ejecting portion Q will be described below with reference to FIG. 8. As shown in FIG. 6, each head unit Hn includes 2N nozzles Nz. N is an integer of 2 or greater. Each nozzle Nz is a through-hole for ejecting ink in the Z2 direction. Specifically, each head unit Hn includes N nozzles Nz that eject the first ink and N nozzles Nz that eject the second ink. Additionally, each head unit Hn defines the in-head supply flow paths R1a and R1b and the in-head discharge flow paths R2a and R2b.

The in-head supply flow paths R1a and R1b are flow paths from an end portion of the head unit Hn in the Z1 direction to the liquid ejecting portion Q. The in-head discharge flow paths R2a and R2b are flow paths from the liquid ejecting portion Q to the end portion of the head unit Hn in the Z1 direction. The in-head supply flow paths R1a and R1b and the in-head discharge flow paths R2a and R2b are referred to as an in-head flow path Rn unless otherwise distinguished.

The head unit Hn includes a case 335 that defines the in-head flow path Rn.

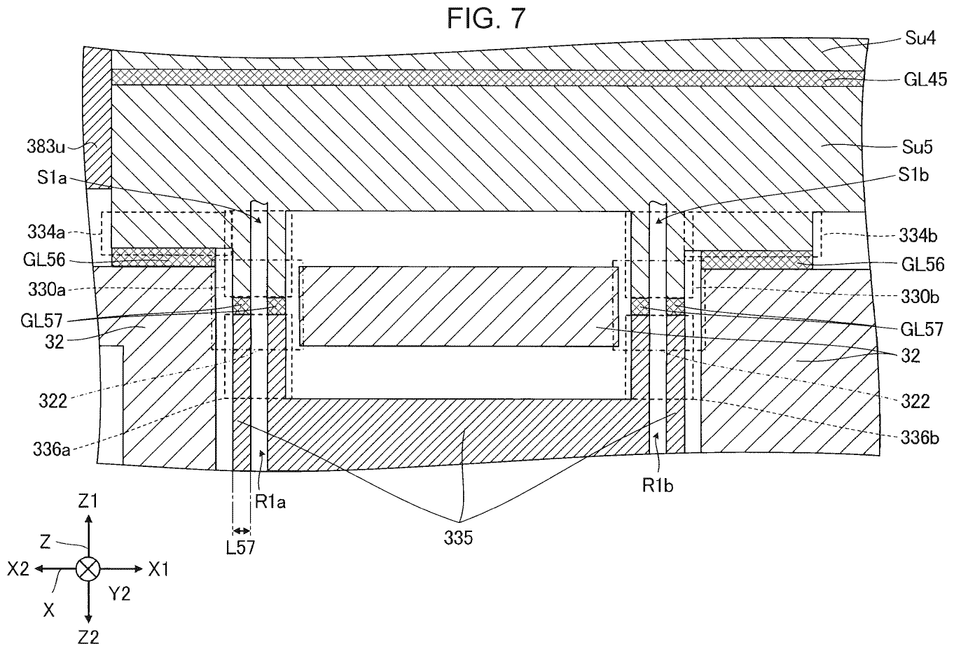

FIG. 7 is an enlarged view of a vicinity of the ink hole 322 shown in FIG. 6. The flow path plate Su5 includes columnar projecting portions 334a and 334b protruding in the Z2 direction. The projecting portions 334a and 334b are bonded in the Z1 direction to the holder member 32 by an adhesive forming the bonding portion GL56.

The flow path plate Su5 includes flow path plate side communication tubes 330a and 330b. The flow path plate side communication tubes 330a and 330b are collectively referred to as a flow path plate side communication tube 330. The flow path plate side communication tube 330 protrudes from the flow path plate Su5 toward the case 335 and is inserted through the ink hole 322.

The case 335 includes case side communication tubes 336a and 336b. The case side communication tubes 336a and 336b are collectively referred to as a case side communication tube 336. The case side communication tube 336 protrudes from the case 335 toward the flow path plate Su5 and is inserted through the ink hole 322.

An adhesive forming a bonding portion GL57 is applied to a top surface of the flow path plate side communication tube 330 and a top surface of the case side communication tube 336.

A flow direction of ink in the in-head supply flow paths R1a and R1b is the Z2 direction. The top surface of the flow path plate side communication tube 330 and the top surface of the case side communication tube 336 are perpendicular to the flow direction of ink.

The description returns to FIGS. 5 and 6. As shown in FIG. 5, the fixing plate 36 is a plate member for fixing the plurality of head units Hn to the holder member 32. The fixing plate 36 includes a plurality of opening portions 361 for exposing the nozzles Nz of the plurality of head units Hn.

The reinforcing plate 37 is disposed between the holder member 32 and the fixing plate 36 and is fixed to the fixing plate 36 by an adhesive. The reinforcing plate 37 includes a plurality of opening portions 371 in which the plurality of head units Hn are disposed.

The wiring substrate 381 is a mounting component for electrically coupling the liquid ejecting head 30 to the control circuit 21 shown in FIG. 4. The wiring substrate 381 is disposed on the laminate 333. The wiring member 382 is installed on the wiring substrate 381. The wiring member 382 is a member for electrically coupling the liquid ejecting head 30 and the control circuit 21. The wiring member 382 is, for example, a connector. The wiring member 382 may be, for example, a signal cable such as a flexible flat cable (FFC).

The circuit boards 383u and 383v are disposed to sandwich the laminate 333 and are electrically coupled to the wiring substrate 381. The flexible substrate 51 mounted on each of the head units H1 and H3 is electrically coupled to the circuit board 383u via a relay substrate (not shown). The flexible substrate 51 mounted on each of the head units H2 and H4 is electrically coupled to the circuit board 383v via a relay substrate (not shown).

### 1-6. Head Unit Hn

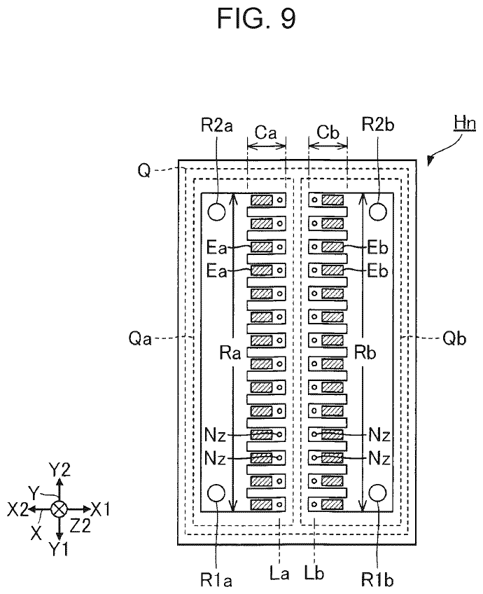

FIG. 8 is a cross-sectional view of the head unit Hn taken along the X-axis direction through the wiring hole 323. The view shown in FIG. 8 is a view of a cross-section of the head unit Hn taken along the X-axis direction through the wiring hole 323 as viewed in the Y2 direction. FIG. 9 is a plan view schematically showing the inside of the head unit Hn. The view shown in FIG. 9 is a plan view of the inside of the head unit Hn as viewed in the Z2 direction. In each of FIGS. 8 and 9, a portion of the head unit Hn shown in FIG. 6 in the vicinity of the fixing plate 36 is shown.

As shown in FIG. 8, the head unit Hn includes the nozzle plate 40, a communication plate 42, a pressure chamber substrate 43, a diaphragm 44, 2N piezoelectric elements E, a protection portion 46, a compliance substrate 45, and the case 335 mentioned above. The piezoelectric element E is an example of a “drive element”.

Each of the nozzle plate 40, the communication plate 42, the pressure chamber substrate 43, and the diaphragm 44 is an elongated plate-shaped member along the Y-axis. The pressure chamber substrate 43 and the case 335 are disposed in the Z1 direction with respect to the communication plate 42. On the other hand, the nozzle plate 40 and the compliance substrate 45 are disposed in the Z2 direction with respect to the communication plate 42. In addition, the members provided in the head unit Hn are joined to each other by an adhesive. Although not shown in FIG. 8, the layer formed by the adhesive joining the members provided in the head unit Hn to each other is also included in the bonding portion GL.

As shown in FIG. 9, the 2N nozzles Nz are classified into a first nozzle row La and a second nozzle row Lb. Each of the first nozzle row La and the second nozzle row Lb is a group of N nozzles Nz arranged linearly along the Y-axis. The first nozzle row La and the second nozzle row Lb are spaced apart from each other and are arranged in the X-axis direction. Here, the liquid ejecting portion Q includes a first liquid ejecting portion Qa including N nozzles Nz belonging to the first nozzle row La, and a second liquid ejecting portion Qb including N nozzles Nz belonging to the second nozzle row Lb. The first liquid ejecting portion Qa ejects the first ink supplied from the sub tank 13a, from each nozzle Nz of the first nozzle row La. The second liquid ejecting portion Qb ejects the second ink supplied from the sub tank 13b, from each nozzle Nz of the second nozzle row Lb.

In the following description, a subscript “a” is added to reference numerals of elements related to the first nozzle row La, and a subscript “b” is added to reference numerals of elements related to the second nozzle row Lb. Additionally, elements related to the first liquid ejecting portion Qa and elements related to the second liquid ejecting portion Qb are disposed in a substantially plane-symmetrical structure. Accordingly, in the following description, elements corresponding to the first liquid ejecting portion Qa will be mainly described, and descriptions of elements corresponding to the second liquid ejecting portion Qb will be omitted as appropriate.

Further, in the following description, a nozzle Nz classified into the first nozzle row La may be referred to as a nozzle Nz[an1], and the nozzle Nz classified into the second nozzle row Lb may be referred to as a nozzle Nz[bn2]. n1 and n2 are integers of 1 or greater and N or less. In addition, hereinafter, a nozzle Nz[a1] to a nozzle Nz[aN] and a nozzle Nz[b1] to a nozzle Nz[bN] may be referred to as a nozzle Nz without distinction. Further, elements related to the nozzle Nz[p1n1] may be described with the subscript [p1n1] added. p1 is a or b. For example, a pressure chamber C communicating with the nozzle Nz[p1n1] may be referred to as a pressure chamber C[p1n1], and a piezoelectric element E that applies pressure to the pressure chamber C[p1n1] may be referred to as a piezoelectric element E[p1n1].

The first liquid ejecting portion Qa includes N individual flow paths RJa respectively communicating with the N nozzles Nz, and the first liquid storage chamber Ra coupled in common to the N individual flow paths RJa. The individual flow path RJa is formed of the second communication flow path R4a, the pressure chamber Ca, and the first communication flow path R3a. Ink flows into the individual flow path RJa from an opening 37Ka, which is an end of the second communication flow path R4a in the Z2 direction. The first liquid storage chamber Ra and the second liquid storage chamber Rb are examples of a “common liquid chamber”. When the first liquid storage chamber Ra corresponds to the “common liquid chamber”, the N individual flow paths RJa correspond to a “plurality of individual flow paths”, and when the second liquid storage chamber Rb corresponds to the “common liquid chamber”, the N individual flow paths RJb correspond to a “plurality of individual flow paths”.

As shown in FIG. 8, the communication plate 42 is provided with the first communication flow path R3a and the second communication flow path R4a. Each of the first communication flow path R3a and the second communication flow path R4a is provided for each nozzle Nz. The nozzle Nz communicates with the pressure chamber Ca, which will be described below, through the first communication flow path R3a. The nozzle Nz communicates with the first liquid storage chamber Ra, which will be described below, through the second communication flow path R4a. Additionally, the compliance substrate 45 constitutes a part of a wall surface of the first liquid storage chamber Ra. The compliance substrate 45 includes, for example, a resin film 45a having flexibility and a metal plate 45b such as stainless steel.

The pressure chamber substrate 43 is provided with N pressure chambers Ca. The pressure chamber Ca is a space that communicates with the nozzle Nz via the first communication flow path R3a. The diaphragm 44 that is elastically deformable is disposed above the pressure chamber Ca. A part or all of the diaphragm 44 may be a separate member from the pressure chamber substrate 43 or may be integrated. In addition, a piezoelectric element Ea is formed for each pressure chamber Ca on a surface of the diaphragm 44 on a side opposite to the pressure chamber Ca. N piezoelectric elements Ea are disposed in one-to-one correspondence with the N nozzles Nz. The piezoelectric element Ea generates energy for ejecting ink. Specifically, the piezoelectric element Ea changes a volume of the pressure chamber Ca by application of the drive signal, thereby ejecting ink from the nozzle Nz.

The piezoelectric element E is a laminate (not shown) in which a piezoelectric body is interposed between an upper electrode to which the offset potential VBS is supplied and a lower electrode to which the drive signal Com is supplied. The piezoelectric element E is, for example, a portion where the lower electrode, the upper electrode, and the piezoelectric body overlap when viewed from the Z1 direction. Additionally, the pressure chamber Ca is provided in the Z2 direction with respect to the piezoelectric element E. In the first embodiment, an aspect is employed in which the offset potential VBS is supplied to the upper electrode and the drive signal Com is supplied to the lower electrode. However, an aspect may also be employed in which the drive signal Com is supplied to the upper electrode and the offset potential VBS is supplied to the lower electrode.

In the first embodiment, the lower electrode is an individual electrode disposed for each piezoelectric element E to be spaced apart from the others. On the other hand, the upper electrode is a band-shaped common electrode extending in a direction along the Y-axis to be continuous over the N piezoelectric elements Ea.

The piezoelectric body is made of a piezoelectric material such as lead zirconate titanate (Pb(Zr, Ti)O₃), and, for example, has a band shape extending in a direction along the Y-axis to be continuous over the N piezoelectric elements Ea. However, the piezoelectric body may be integrated over the N piezoelectric elements Ea. In this case, in the piezoelectric body, through-holes penetrating through the piezoelectric body layer are provided in regions corresponding, in plan view, to gaps between adjacent pressure chambers Ca to extend in a direction along the X-axis. When the diaphragm 44 vibrates in conjunction with deformation of the piezoelectric element Ea described above, pressure in the pressure chamber Ca fluctuates, whereby ink is ejected from the nozzle Nz.

The description returns to FIG. 8. The protection portion 46 is disposed above the diaphragm 44. In addition, the flexible substrate 51 is joined to a surface of the diaphragm 44. A plurality of wirings for electrically coupling the control circuit 21 and the head unit Hn are formed at the flexible substrate 51. Further, a drive circuit 50 that drives the piezoelectric element E is mounted on the flexible substrate 51. The drive circuit 50 selects whether or not to supply various signals, such as a drive signal for driving each piezoelectric element Ea, to each piezoelectric element Ea based on signals output from the control circuit 21.

The case 335 includes the first liquid storage chamber Ra for storing ink. Additionally, the case 335 includes a part of the in-head supply flow paths R1a and R1b and the in-head discharge flow paths R2a and R2b mentioned above. As shown in FIG. 8, each of the in-head supply flow path R1a and the in-head discharge flow path R2a is coupled to the first liquid storage chamber Ra. Further, as shown in FIG. 8, the case 335 includes a substrate hole 411 through which the flexible substrate 51 is inserted.

### 1-7. Shape of In-Structure Flow Path Sn

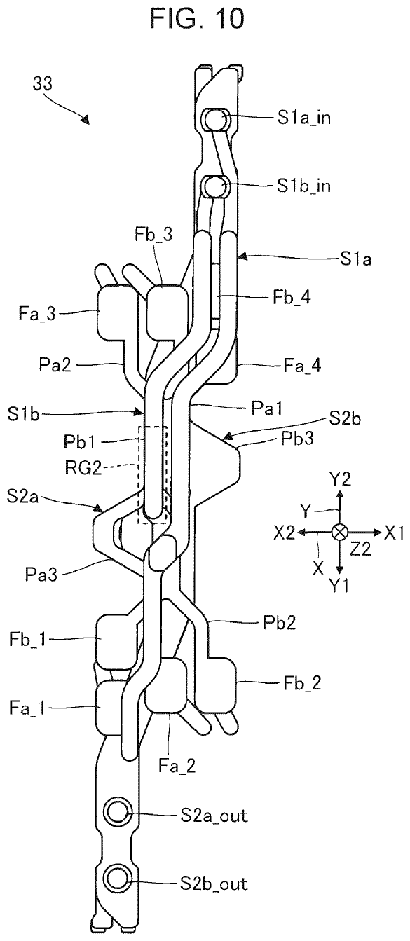

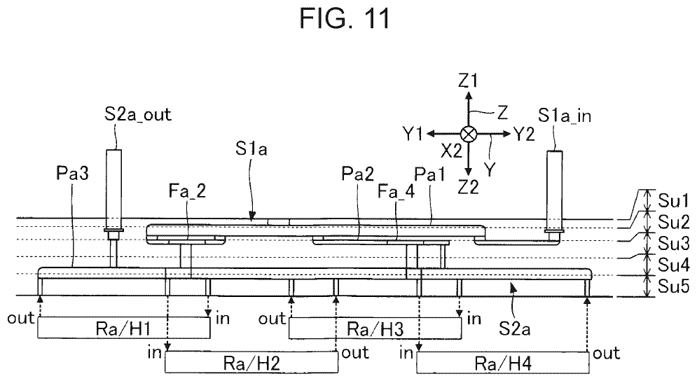

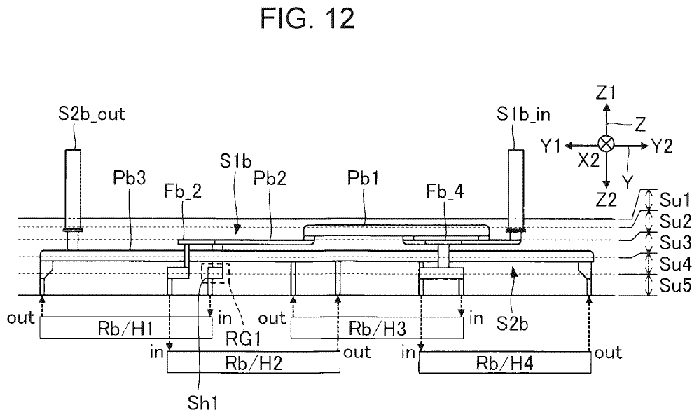

FIG. 10 is a plan view exemplifying the in-structure flow path Sn. FIG. 11 is a side view of the in-structure supply flow path S1a and the in-structure discharge flow path S2a of the in-structure flow path Sn, through which the first ink flows. FIG. 12 is a side view of the in-structure supply flow path S1b and the in-structure discharge flow path S2b of the in-structure flow path Sn, through which the second ink flows. In FIGS. 11 and 12, the first liquid storage chamber Ra of each head unit Hn is indicated by reference numeral “Ra/Hn”, and the second liquid storage chamber Rb of each head unit Hn is indicated by reference numeral “Rb/Hn”. The configuration of the in-structure flow path Sn is not limited to the following configuration.

As exemplified in FIGS. 10, 11, and 12, the flow path structure 33 is provided with the in-structure supply flow paths S1a and S1b and the in-structure discharge flow paths S2a and S2b. The in-structure supply flow path S1a is a flow path from the supply port S1a_in to the in-head supply flow path R1a of each head unit Hn, and the in-structure discharge flow path S2a is a flow path from the in-head discharge flow path R2a of each head unit Hn to the discharge port S2a_out. The in-structure supply flow path S1b is a flow path from the supply port S1b_in to the in-head supply flow path R1b of each head unit Hn, and the in-structure discharge flow path S2b is a flow path from the in-head discharge flow path R2b of each head unit Hn to the discharge port S2b_out.

As exemplified in FIGS. 10 and 11, the in-structure supply flow path S1a is a flow path including a supply portion Pa1, a coupling portion Pa2, and four filter portions Fa_1 to Fa_4. As exemplified in FIG. 11, the supply portion Pa1 is formed between the flow path plates Su1 and Su2. The supply portion Pa1 has a shape extending along the Y-axis. An end portion of the supply portion Pa1 in the Y2 direction communicates with the supply port S1a_in. The in-structure supply flow path S1a is a flow path including a supply portion Pb1, a coupling portion Pb2, and four filter portions Fb_1 to Fb_4. The supply portion Pb1 is formed between the flow path plates Su1 and Su2. The supply portion Pb1 has a shape extending along the Y-axis. An end portion of the supply portion Pb1 in the Y2 direction communicates with the supply port S1b_in.

The coupling portion Pa2 and the four filter portions Fa_1 to Fa_4 are formed between the flow path plates Su2 and Su3. The coupling portion Pa2 communicates with the supply portion Pa1 via a through-hole formed in the flow path plate Su2. The coupling portion Pa2 extends in the Y2 direction from a coupling position to the supply portion Pa1 and branches into two systems to communicate with the filter portions Fa_1 and Fa_3.

The filter portion Fa_2 communicates with the supply portion Pa1 via a through-hole formed in the flow path plate Su2. The filter portion Fa_4 communicates with the supply portion Pa1 via a through-hole formed in the flow path plate Su2. Each of the filter portions Fa_1 to Fa_4 communicates with the in-head supply flow path R1a of each head unit Hn via a through-hole penetrating through the flow path plates Su3 to Su5.

As exemplified in FIGS. 10 and 12, the in-structure supply flow path S1b is a flow path including a supply portion Pb1, a coupling portion Pb2, and four filter portions Fb_1 to Fb_4. The supply portion Pb1 is formed between the flow path plates Su1 and Su2. The supply portion Pb1 has a shape extending along the Y-axis. The supply port S1b_in communicates with an end of the supply portion Pb1 in the Y2 direction. Here, the supply portions Pa1 and Pb1 are provided in parallel between the flow path plates Su1 and Su2.

The coupling portion Pb2 and the four filter portions Fb_1 to Fb_4 are formed between the flow path plates Su2 and Su3. The coupling portion Pb2 communicates with the supply portion Pb1 via a through-hole formed in the flow path plate Su2. The coupling portion Pb2 extends in the Y1 direction from a coupling position to the supply portion Pb1 and branches into two systems to communicate with the filter portions Fb_2 and Fb_4. Here, the coupling portion Pb2 extends in a direction opposite to the coupling portion Pa2 from the coupling position to the supply portion Pb1.

The filter portion Fb_1 communicates with the supply portion Pb1 via a through-hole formed in the flow path plate Su2. The filter portion Fb_3 communicates with the supply portion Pb1 via a through-hole formed in the flow path plate Su2. Each of the filter portions Fb_1 to Fb_4 communicates with the in-head supply flow path R1b of each head unit Hn via a through-hole penetrating through the flow path plates Su3 to Su5.

As exemplified in FIGS. 10 and 11, the in-structure discharge flow path S2a is a flow path including a discharge portion Pa3. The discharge portion Pa3 is formed between the flow path plates Su4 and Su5. The discharge portion Pa3 has a shape that extends along the Y-axis over a wider range than the supply portion Pa1. A vicinity of an end portion of the discharge portion Pa3 in the Y1 direction communicates with the discharge port S2a_out. The in-head discharge flow path R2a of each head unit Hn communicates with the discharge portion Pa3 via a through-hole penetrating through the flow path plate Su5.

As exemplified in FIGS. 10 and 12, the in-structure discharge flow path S2b is a flow path including a discharge portion Pb3. The discharge portion Pb3 is formed between the flow path plates Su3 and Su4. The discharge portion Pb3 has a shape that extends along the Y-axis over a wider range than the supply portion Pb1. A vicinity of an end portion of the discharge portion Pb3 in the Y1 direction communicates with the discharge port S2b_out. The in-head discharge flow path R2b of each head unit Hn communicates with the discharge portion Pb3 via a through-hole penetrating through the flow path plates Su4 and Su5.

In order to detect a sign of ink leakage from the flow path of the liquid ejecting head 30 to the outside, in the present disclosure, a sign of ink leakage from the liquid ejecting head 30 is detected using the detection space FA and residual vibration acquired for purposes such as specifying an ejection abnormality of the nozzle Nz. The residual vibration indicates vibration remaining in the pressure chamber C after the piezoelectric element E is driven. Hereinafter, a method of acquiring the residual vibration information NEI indicating residual vibration will be described using an electrical configuration and an operation of the liquid ejecting head 30.

### 1-8. Electrical Configuration of Liquid Ejecting Head 30

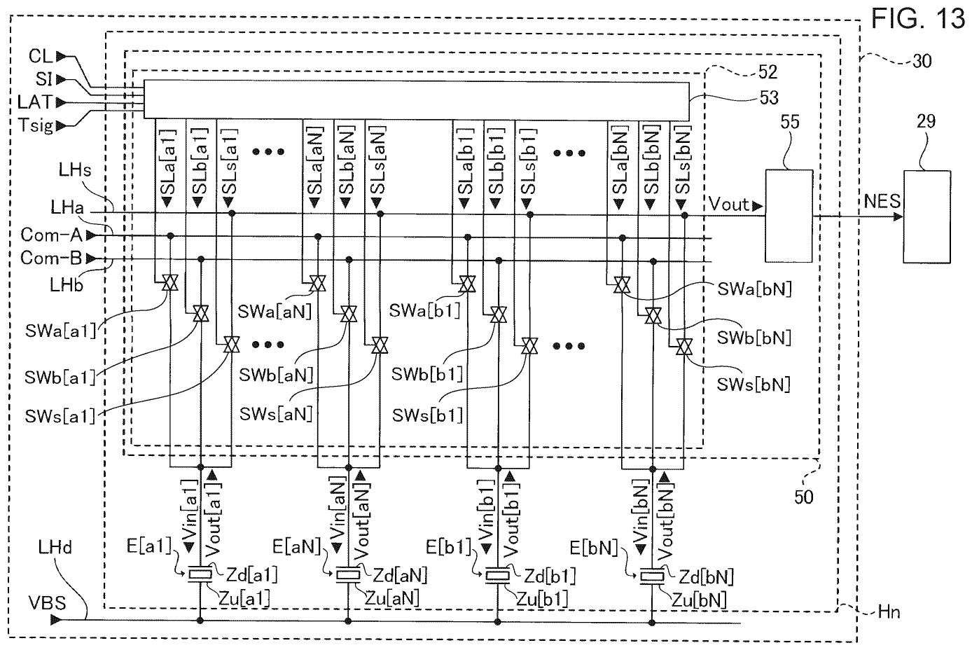

Hereinafter, the configuration of the liquid ejecting head 30 will be described with reference to FIG. 13.

FIG. 13 is a block diagram showing an example of the electrical configuration of the liquid ejecting head 30. FIG. 13 shows the head unit Hn provided in the liquid ejecting head 30.

The drive circuit 50 includes a switching circuit 52 and a detection circuit 55. Under the control of the control circuit 21, the switching circuit 52 switches whether or not to supply the drive signal Com output from the drive signal generation circuit 114 to each of the plurality of piezoelectric elements E provided in the head unit Hn. In addition, the switching circuit 52 switches whether or not to electrically couple each piezoelectric element E to the detection circuit 55. In the present embodiment, it is assumed that the drive signal Com includes drive signals Com-A and Com-B. Further, in the drive signals Com-A and Com-B, a signal actually supplied to the piezoelectric element E may be referred to as a supply drive signal Vin. The switching circuit 52 includes, for example, a group of switches such as a transmission gate for the switching. The detection circuit 55 outputs a residual vibration signal NES indicating vibration remaining in the pressure chamber C, which will be described below, to the generation circuit 29 after the piezoelectric element E is driven. More specifically, the detection circuit 55 generates the residual vibration signal NES based on a detection signal Vout detected from the piezoelectric element E driven by the drive signal Com.

The liquid ejecting head 30 includes an internal wiring LHa to which the drive signal Com-A is supplied from the drive signal generation circuit 114, an internal wiring LHb to which the drive signal Com-B is supplied from the drive signal generation circuit 114, an internal wiring LHs for supplying the detection signal Vout detected from the piezoelectric element E to the detection circuit 55, and an internal wiring LHd to which the offset potential VBS is supplied, in addition to the head unit Hn.

As shown in FIG. 13, the switching circuit 52 includes 2N switches SWa[a1] to SWa[bN], 2N switches SWb[a1] to SWb[bN], 2N switches SWs[a1] to SWs[bN], and a coupling state designation circuit 53 that designates a coupling state of each switch. As each switch, for example, a transmission gate can be employed.

The coupling state designation circuit 53 generates coupling state designation signals SLa[a1] to SLa[bN] for designating ON/OFF of the switches SWa[a1] to SWa[bN], coupling state designation signals SLb[a1] to SLb[bN] for designating ON/OFF of the switches SWb[a1] to SWb[bN], and coupling state designation signals SLs[a1] to SLs[bN] for designating ON/OFF of the switches SWs[a1] to SWs[bN] based on at least a part of a print signal SI, a latch signal LAT, and a period designation signal Tsig supplied from the control circuit 21.

A switch SWa[p1n1] switches conduction and non-conduction between the internal wiring LHa and the lower electrode [p1n1] of the piezoelectric element E[p1n1] in accordance with the coupling state designation signal SLa[p1n1]. For example, the switch SWa[p1n1] is turned on when the coupling state designation signal SLa[p1n1] is at a high level, and is turned off when the coupling state designation signal SLa[p1n1] is at a low level.

A switch SWb[p1n1] switches conduction and non-conduction between the internal wiring LHb and the lower electrode [p1n1] of the piezoelectric element E[p1n1] in accordance with the coupling state designation signal SLb[p1n1]. For example, the switch SWb[p1n1] is turned on when the coupling state designation signal SLb[p1n1] is at a high level, and is turned off when the coupling state designation signal SLb[p1n1] is at a low level.

A switch SWs[p1n1] switches conduction and non-conduction between the internal wiring LHs and the lower electrode [p1n1] of the piezoelectric element E[p1n1] in accordance with the coupling state designation signal SLs[p1n1]. For example, the switch SWs[p1n1] is turned on when the coupling state designation signal SLs[p1n1] is at a high level, and is turned off when the coupling state designation signal SLs[p1n1] is at a low level.

A detection signal Vout[p1n1] output from the piezoelectric element E[p1n1] is supplied to the detection circuit 55 via the internal wiring LHs. Then, the detection circuit 55 generates the residual vibration signal NES based on the detection signal Vout[p1n1]. The residual vibration signal NES is an analog signal.

The detection circuit 55 may include, for example, a negative feedback amplifier for amplifying the detection signal Vout, a low-pass filter for attenuating a high-frequency component of the detection signal Vout, and a voltage follower that converts impedance and outputs the residual vibration signal NES with low impedance.

The generation circuit 29 generates the residual vibration information NEI regarding the residual vibration based on the residual vibration signal NES. The residual vibration information NEI is a digital signal. For example, the generation circuit 29 samples the residual vibration signal NES at regular periods, and generates, as the residual vibration information NEI, information in which time information indicating a time at sampling with any starting time point as a reference is associated with a value indicating a potential obtained by the sampling.

### 1-9. Operation of Liquid Ejecting Head 30

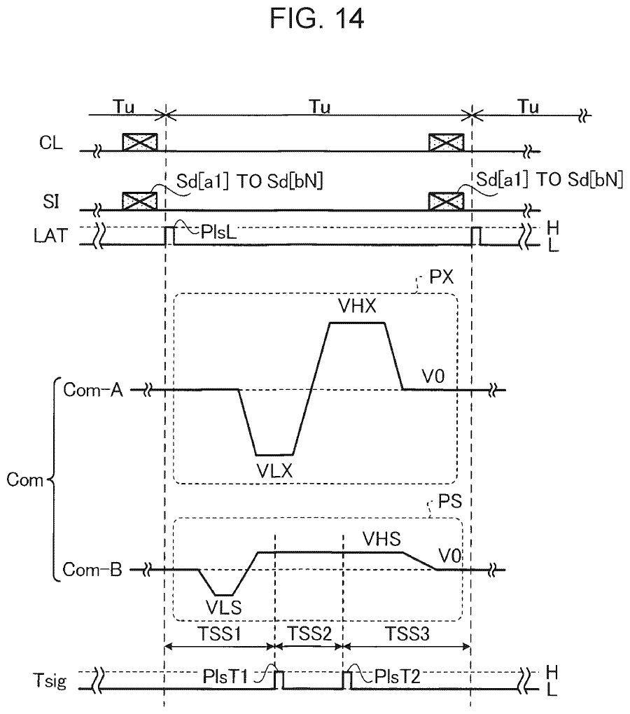

Hereinafter, the operation of the liquid ejecting head 30 will be described with reference to FIG. 14. In the present embodiment, an operation period of the ink jet printer 100 includes one or more recording periods Tu. It is assumed that the ink jet printer 100 according to the present embodiment executes, in each recording period Tu, one of the driving of each piezoelectric element E in the printing process and the driving of each piezoelectric element E for acquiring the residual vibration information NEI. However, the present disclosure is not limited to such an aspect, and both the driving of each piezoelectric element E in the printing process and the driving of each piezoelectric element E for acquiring the residual vibration information NEI may be executable in each recording period Tu. Hereinafter, a process of acquiring the residual vibration information NEI may be referred to as a residual vibration acquisition process.

In general, the ink jet printer 100 forms an image based on the image data Img by ejecting ink one or more times from each nozzle Nz over a plurality of continuous or intermittent recording periods Tu.

FIG. 14 is a timing chart illustrating an operation of the ink jet printer 100 in the recording period Tu. As shown in FIG. 14, the control circuit 21 outputs a latch signal LAT having a pulse PlsL. As a result, the control circuit 21 defines the recording period Tu as a period from a rising edge of the pulse PlsL to a rising edge of the next pulse PlsL.

The print signal SI includes individual designation signals Sd[a1] to Sd[bN] for designating driving aspects of the piezoelectric elements E[a1] to E[bN] in each recording period Tu. Then, when at least one of the printing process and the residual vibration acquisition process is executed in the recording period Tu, the control circuit 21 supplies, as shown in FIG. 14, a print signal SI including individual designation signals Sd[a1] to Sd[bN] to the coupling state designation circuit 53 in synchronization with a clock signal CL prior to a start of the recording period Tu. In this case, the coupling state designation circuit 53 generates the coupling state designation signals SLa[p1n1], SLb[p1n1], and SLs[p1n1] based on the individual designation signals Sd[p1n1] in the recording period Tu.

The individual designation signal Sd[p1n1] according to the present embodiment is a signal for designating, in each recording period Tu, one driving aspect among three driving aspects including driving for ink ejection, driving for non-ejection of ink, and driving as an operation target for the residual vibration acquisition process, with respect to the piezoelectric element E[p1n1].

As shown in FIG. 14, the drive signal generation circuit 114 outputs the drive signal Com-A having an ejection waveform PX. The ejection waveform PX has a lowest potential VLX and a highest potential VHX. The ejection waveform PX has a potential at a start and an end set to a reference potential V0.

When the individual designation signal Sd[n1] designates the ejection of ink with respect to the piezoelectric element E[n1], the coupling state designation circuit 53 sets the coupling state designation signal SLa[n1] to a high level in the recording period Tu and sets the coupling state designation signals SLb[n1] and SLs[n1] to a low level in the recording period Tu. In this case, the nozzle Nz[n1] ejects ink in the recording period Tu, and dots are formed on the medium PP.

As shown in FIG. 14, the drive signal generation circuit 114 outputs the drive signal Com-B having an inspection waveform PS provided in the recording period Tu. In the present embodiment, the inspection waveform PS is defined such that a potential difference between a highest potential VHS and a lowest potential VLS of the inspection waveform PS is smaller than a potential difference between the highest potential VHX and the lowest potential VLX of the ejection waveform PX. Specifically, when the drive signal Com-B having the inspection waveform PS is supplied to the piezoelectric element E[n1], the inspection waveform PS is defined such that the piezoelectric element E[n1] is driven to such an extent that ink is not ejected from the nozzle Nz[n1]. The inspection waveform PS has a potential at a start and an end set to the reference potential V0.

Additionally, the control circuit 21 outputs the period designation signal Tsig having a pulse PlsT1 and a pulse PlsT2. As a result, the control circuit 21 classifies the recording period Tu into a control period TSS1 from the start of the pulse PlsL to the start of the pulse PlsT1, a control period TSS2 from the start of the pulse PlsT1 to the start of the pulse PlsT2, and a control period TSS3 from the start of the pulse PlsT2 to the start of the next pulse PlsL.

When the individual designation signal Sd[n1] designates the nozzle Nz[n1] as the operation target for the residual vibration acquisition process, the coupling state designation circuit 53 sets the coupling state designation signal SLa[n1] to a low level in the recording period Tu, sets the coupling state designation signal SLb[n1] to a high level in the control periods TSS1 and TSS3 and to a low level in the control period TSS2, and sets the coupling state designation signal SLs[n1] to a low level in the control periods TSS1 and TSS3 and to a high level in the control period TSS2.

In this case, the piezoelectric element E[n1] is driven by the drive signal Com-B of the inspection waveform PS in the control period TSS1. As a result, vibration occurs in the pressure chamber C[n1], and this vibration remains even in the control period TSS2. In the control period TSS2, the lower electrode provided in the piezoelectric element E[n1] changes the potential in response to the residual vibration occurring in the pressure chamber C[n1]. In other words, in the control period TSS2, the lower electrode provided in the piezoelectric element E[n1] indicates a potential corresponding to an electromotive force of the piezoelectric element E[n1] caused by the residual vibration occurring in the pressure chamber C[n1]. Then, the potential of the lower electrode can be detected as the detection signal Vout in the control period TSS2.

### 1-10. Concerning Detection Space FA

The control circuit 21 can specify an ejection abnormality of the liquid ejecting head 30 through analysis using the residual vibration information NEI. For example, when an abnormality occurs in an ejection state of the nozzle Nz due to bubbles being mixed into the nozzle Nz, a frequency of residual vibration becomes higher as compared with when bubbles are not mixed into the nozzle Nz. In addition, in general, when an abnormality occurs in the ejection state of the nozzle Nz due to foreign matter such as paper dust adhering in the vicinity of the nozzle Nz, the frequency of residual vibration becomes lower as compared with when foreign matter does not adhere. Accordingly, the ink jet printer 100 can select an appropriate cleaning process by analyzing the type of ejection abnormality using the residual vibration information NEI.

The inventor found that characteristics of the residual vibration also differ depending on whether or not ink is present in the pressure chamber C. Specifically, the inventor found that, when no ink is present in the pressure chamber C, as compared with when ink is present in the pressure chamber C, a period until residual vibration attenuates is shorter and an amplitude at the second and subsequent peaks of the residual vibration is smaller. Accordingly, in the present embodiment, by using a mechanism that acquires the residual vibration information NEI, at least a part of one or more of individual flow paths RJ among 2N individual flow paths RJ is used as a detection space FA, and the detection space FA is partitioned from the flow path SF by a fragile bonding portion GLW that is intentionally made more fragile than the bonding portion GL. When the ink leaks from the fragile bonding portion GLW and the ink is present in the detection space FA, the control circuit 21 can detect the ink leakage from the fragile bonding portion GLW based on the residual vibration information NEI. That is, the detection space FA is a space that, in an initial state of the liquid ejecting head 30, is not a part of the flow path SF, but becomes a part of the flow path SF after ink leaks from the fragile bonding portion GLW. In the present specification, the initial state of the liquid ejecting head 30 means a state after the liquid ejecting head 30 is manufactured and before the liquid ejecting head 30 is filled with ink. Additionally, the initial state of the liquid ejecting head 30 can also be referred to as a state in which the bonding portion GL is not in contact with ink. When ink leaks from the fragile bonding portion GLW, it can be estimated that the bonding portion GL is deteriorated and that ink may soon leak from the bonding portion GL, by analyzing the residual vibration information NEI acquired from the piezoelectric element E that applies pressure to the pressure chamber C of the individual flow path RJ used as the detection space FA.

For simplification of description, in the first embodiment, unless otherwise specified, the description will be given on the assumption that all of the individual flow paths RJ are used as the detection space FA. The individual flow path RJ used as the detection space FA may be any one of the 2N individual flow paths RJ, but is preferably an individual flow path RJ positioned at an end in the Y1 direction or an individual flow path RJ positioned at an end in the Y2 direction among the 2N individual flow paths RJ. In addition, among the 2N individual flow paths RJ, one of an individual flow path RJ communicating with the nozzle Nz classified into the first nozzle row La and an individual flow path RJ communicating with the nozzle Nz classified into the second nozzle row Lb may be used as the detection space FA, or both may be used as the detection space FA. Hereinafter, for simplification of description, the description will be given using an example in which the individual flow path RJ[aN] is used as the detection space FA.

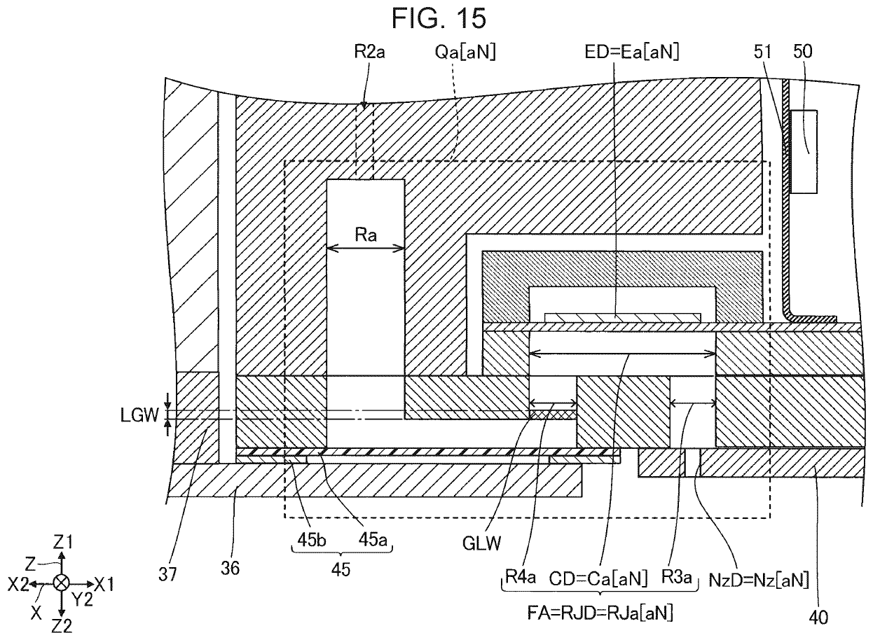

FIG. 15 is a view illustrating the detection space FA in the first embodiment. In FIG. 15, the individual flow path RJ[aN] used as the detection space FA is enlarged. Hereinafter, for simplification of description, the individual flow path RJ used as the detection space FA may be referred to as a dummy individual flow path RJD. Similarly, the pressure chamber C provided in the dummy individual flow path RJD may be referred to as a dummy pressure chamber CD, the piezoelectric element E that applies pressure to the inside of the dummy pressure chamber CD may be referred to as a dummy piezoelectric element ED, and the nozzle Nz communicating with the dummy individual flow path RJD may be referred to as a dummy nozzle NzD. In the example of FIG. 15, a pressure chamber Ca[aN] is the dummy pressure chamber CD, the piezoelectric element Ea[aN] is the dummy piezoelectric element ED, and the nozzle Nz[aN] is the dummy nozzle NzD.

The dummy individual flow path RJD, the dummy piezoelectric element ED, and the dummy nozzle NzD used as the detection space FA do not directly contribute to forming an image on the medium PP. The phrase “do not directly contribute to forming an image” means that it is not used to eject ink onto the medium PP to form dots for constituting a part of an image on the medium PP. Since the dummy individual flow path RJD communicates with the dummy nozzle NzD, the dummy individual flow path RJD is not a sealed space.

The dummy individual flow path RJD is partitioned from the first liquid storage chamber Ra by the fragile bonding portion GLW. The fragile bonding portion GLW is provided to cover the opening 37Ka, that is, at an end of the second communication flow path R4a in the Z2 direction.

The fragile bonding portion GLW is preferably provided to be intentionally more likely to deteriorate than a bonding portion GL that is most likely to deteriorate among a plurality of bonding portions GL in the liquid ejecting head 30. The bonding portion GL that is most likely to deteriorate among the plurality of bonding portions GL in the liquid ejecting head 30 is, when conditions of ink in contact with the plurality of bonding portions GL in the liquid ejecting head 30 are the same, a bonding portion GL in which the shortest distance from a position that defines the flow path SF in the initial state of the liquid ejecting head 30 to a position on a side opposite to an end of the bonding portion GL that defines the flow path SF is shortest. Hereinafter, in the initial state of the liquid ejecting head 30, a shortest distance from a portion where the bonding portion GL or the fragile bonding portion GLW defines the flow path SF to a portion on a side opposite to the end defining the flow path SF may be referred to as an “ink penetration distance”. In the present embodiment, the description will be given on the assumption that the bonding portion GL57 is the bonding portion GL most likely to deteriorate. However, when the conditions of ink in contact with the plurality of bonding portions GL in the liquid ejecting head 30 are different from each other, the bonding portion GL most likely to deteriorate may be a bonding portion GL provided at a location where a flow rate in the flow path SF is large, or may be a bonding portion GL provided at a location where a temperature in the flow path SF is high. A location where a temperature in the flow path SF is high is a vicinity of the piezoelectric element E, and a vicinity of a heater (not shown) that is provided when ink that needs to be used in a high temperature state, such as UV ink, is employed.

In the first embodiment, the bonding portion GL57 is an example of a “first bonding portion”, the flow path plate Su5 is an example of a “first flow path member”, and the case 335 is an example of a “second flow path member”. The fragile bonding portion GLW is an example of a “second bonding portion”. However, a set of the “first flow path member” and the “second flow path member” is not limited to a set of the flow path plate Su5 and the case 335, and need only be two members constituting the liquid ejecting head 30, constituting a part of the flow path SF, and bonded using some kind of adhesive. Specifically, the set of two flow path members is a set of two adjacent flow path plates Su in the flow path structure 33, and is a set of two members constituting the head unit Hn, constituting a part of the flow path SF, and bonded using some kind of adhesive. The set of two members in the head unit Hn is specifically a set of the case 335 and the communication plate 42, a set of the communication plate 42 and the pressure chamber substrate 43, a set of the communication plate 42 and the compliance substrate 45, a set of the communication plate 42 and the nozzle plate 40, and a set of the pressure chamber substrate 43 and the diaphragm 44.

An aspect in which the fragile bonding portion GLW is intentionally made more likely to deteriorate than the bonding portion GL57 has the following two aspects. In a first aspect of the fragile bonding portion GLW, an adhesive forming the fragile bonding portion GLW and an adhesive forming the bonding portion GL57 are of the same type, and an ink penetration distance LGW of the fragile bonding portion GLW is shorter than an ink penetration distance L57 of the bonding portion GL57, as shown in FIG. 7. The ink penetration distance LGW is a length of the fragile bonding portion GLW in the direction along the Z-axis in the initial state of the liquid ejecting head 30. In other words, the ink penetration distance LGW is the shortest distance from an end surface of the fragile bonding portion GLW in the Z2 direction that defines the first liquid storage chamber Ra to an end surface of the fragile bonding portion GLW in the Z1 direction that defines the detection space FA. The ink penetration distance L57 is a length of the bonding portion GL57 in the direction along the X-axis in the initial state of the liquid ejecting head 30. In other words, the ink penetration distance L57 is the shortest distance from an end surface of the bonding portion GL57 in the X1 direction that defines the first liquid storage chamber Ra to an end surface on a side opposite to the end surface in the X1 direction that defines the first liquid storage chamber Ra.

In a second aspect of the fragile bonding portion GLW, a liquid resistance of the fragile bonding portion GLW is lower than a liquid resistance of the bonding portion GL57. However, it is preferable that the liquid resistance of the fragile bonding portion GLW is slightly lower than the liquid resistance of the bonding portion GL57. For example, by changing a ratio of a main agent to a curing agent of the fragile bonding portion GLW with respect to a ratio of a main agent to a curing agent of the bonding portion GL57, it is possible to create the fragile bonding portion GLW with slightly weakened liquid resistance. Alternatively, at a time point of manufacture of the liquid ejecting head 30, it is also possible to lower a final curing degree of the fragile bonding portion GLW by locally applying heat with a laser or the like to the fragile bonding portion GLW so that a curing reaction proceeds only halfway.

The fragile bonding portion GLW may be provided at a location other than the opening 37Ka, and may be provided, for example, at an end of the second communication flow path R4a in the Z1 direction or in the middle of the second communication flow path R4a. An aspect in which the fragile bonding portion GLW is provided at the end of the second communication flow path R4a in the Z1 direction and an aspect in which the fragile bonding portion GLW is provided in the middle of the second communication flow path R4a are examples of an aspect in which a part of the individual flow path RJ is used as the detection space FA. In the aspect in which a part of the individual flow path RJ is used as the detection space FA, bubbles may stay in a flow path of the individual flow paths RJ that is not used as the detection space FA, and contact of the fragile bonding portion GLW with ink may be hindered by the bubbles. In this manner, an aspect in which all of the individual flow paths RJ are used as the detection space FA makes a contact period of the fragile bonding portion GLW with ink closer to a contact period of the bonding portion GL57 with ink as compared with an aspect in which a part of the individual flow path RJ is used as the detection space FA, and can improve accuracy of estimating deterioration of the bonding portion GL57.

Additionally, in the example of FIG. 15, the dummy nozzle NzD communicates with the dummy individual flow path RJD, but the dummy nozzle NzD need not be provided. However, by providing the dummy nozzle NzD, when ink penetrates into the dummy individual flow path RJD, air and ink in the dummy individual flow path RJD are quickly replaced through the dummy nozzle NzD. Accordingly, an aspect in which the dummy nozzle NzD communicates with the dummy individual flow path RJD can detect a sign of ink leakage from the liquid ejecting head 30 more quickly when ink penetrates from the fragile bonding portion GLW, as compared with an aspect in which the dummy nozzle NzD is not provided.

### 1-11. Functions of First Embodiment

The deterioration state of the bonding portion GL57 can be estimated by the residual vibration information NEI obtained from the dummy piezoelectric element ED. In addition, it is preferable to replace the liquid ejecting head 30 before ink leaks from the liquid ejecting head 30. Accordingly, in the ink jet system SYS, when it is estimated that the bonding portion GL57 is in a deteriorated state, a function of prompting the user U to replace the liquid ejecting head 30 is provided.

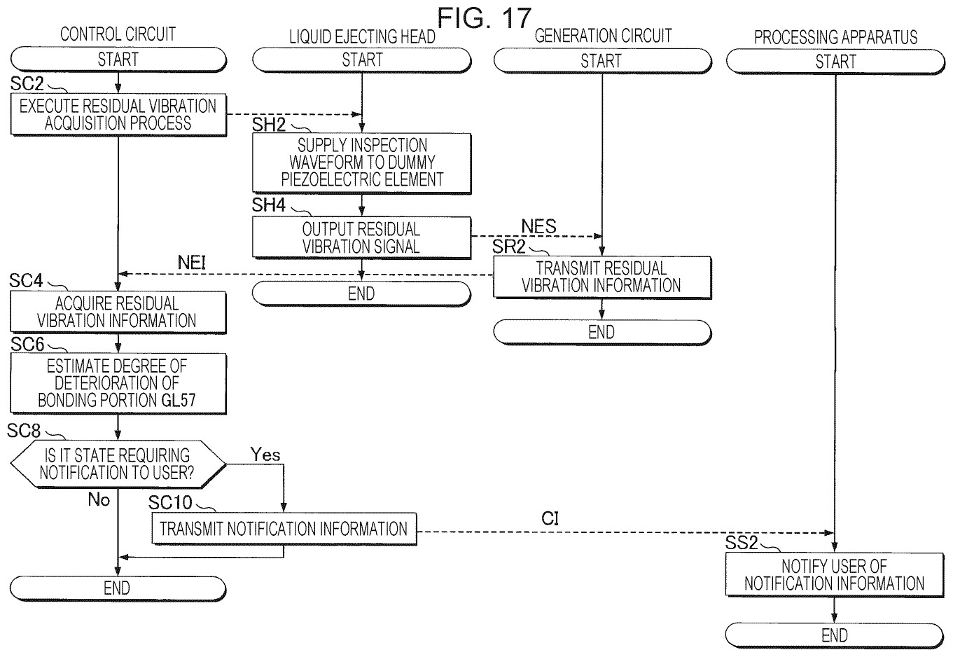

FIG. 16 is a diagram showing a function of the ink jet system SYS. FIG. 17 is a flowchart showing an operation of the ink jet system SYS. The control circuit 21 functions as an acquisition section 71, an estimation section 73, and a notification section 75 by executing the read control program PM2.

A series of processes shown in FIG. 17 are periodically executed. For example, the ink jet system SYS executes the series of processes shown in FIG. 17 every day, every week, or every month. However, the series of processes shown in FIG. 17 may be executed irregularly. For example, when the ink jet system SYS receives the image data Img from the processing apparatus 200, the ink jet system SYS may execute the series of processes shown in FIG. 17 before the printing process, or may execute the series of processes shown in FIG. 17 in response to an instruction from the user U.

Even though the fragile bonding portion GLW is not deteriorated, ink may be pushed from the dummy nozzle NzD into the dummy individual flow path RJD, and air in the dummy individual flow path RJD may be replaced with ink by a wiping process performed before and after the printing process. In order to discharge ink in the dummy individual flow path RJD in a state in which the fragile bonding portion GLW is not deteriorated, it is preferable to execute the cleaning process before executing the series of processes shown in FIG. 17.

In step SC2, the control circuit 21 executes the residual vibration acquisition process. Specifically, the control circuit 21 outputs the waveform designation signal dCom for generating the drive signal Com-B including the inspection waveform PS to the drive signal generation circuit 114, and transmits the print signal SI including the individual designation signal Sd indicating that the drive signal Com-B is supplied to the dummy piezoelectric element ED to the liquid ejecting head 30. After the end of processing in step SC2, the control circuit 21 waits for a response from the generation circuit 29.

In step SH2, the liquid ejecting head 30 supplies the drive signal Com-B including the inspection waveform PS to the dummy piezoelectric element ED in accordance with an instruction of the print signal SI from the control circuit 21. Then, in step SH4, the liquid ejecting head 30 outputs the residual vibration signal NES to the generation circuit 29. After the end of processing in step SH4, the liquid ejecting head 30 ends the series of processes shown in FIG. 17.

When the generation circuit 29 receives the residual vibration signal NES of the liquid ejecting head 30, in step SR2, the generation circuit 29 generates the residual vibration information NEI based on the residual vibration signal NES, and transmits the residual vibration information NEI to the control circuit 21. After the end of processing in step SR2, the generation circuit 29 ends the series of processes shown in FIG. 17.

The control circuit 21 functions as the acquisition section 71 to acquire the residual vibration information NEI from the generation circuit 29 in step SC4. The acquired residual vibration information NEI can be said to be information regarding the presence or absence of ink in the dummy individual flow path RJD as the detection space FA.

Next, the control circuit 21 functions as the estimation section 73 to estimate a degree of deterioration of the bonding portion GL57 based on the residual vibration information NEI in step SC6. Specifically, in order to estimate the degree of deterioration of the bonding portion GL57, the storage circuit 22 stores a period threshold value indicating a period until the residual vibration attenuates when ink can be regarded as being present in the dummy individual flow path RJD, and an amplitude threshold value indicating an amplitude at a second peak of the residual vibration. The period until the residual vibration attenuates is, for example, a period from a start time of the residual vibration to a time when a value of the amplitude at the second or subsequent peak with respect to an amplitude at a first peak of the residual vibration becomes equal to or less than a predetermined value such as equal to or less than one-tenth. The control circuit 21 specifies, from the residual vibration information NEI, a period until the residual vibration attenuates and an amplitude at a second peak of the residual vibration. Then, when the specified period is shorter than the period threshold value and the specified amplitude is smaller than the amplitude threshold value, the control circuit 21 estimates that the bonding portion GL57 is deteriorated, since ink leaks from the fragile bonding portion GLW and ink is present in the dummy individual flow path RJD.

After the end of processing in step SC6, in step SC8, the control circuit 21 determines whether or not it is a state requiring a notification to the user U, based on an estimation result. More specifically, when it is estimated that the bonding portion GL57 is deteriorated, the control circuit 21 determines that it is a state requiring a notification to the user U.

When a determination result in step SC8 is affirmative, in step SC10, the control circuit 21 functions as the notification section 75, generates the notification information CI based on the estimation result, and notifies the user U of the generated notification information CI. Specifically, the control circuit 21 transmits the notification information CI to the processing apparatus 200 and causes the processing apparatus 200 to notify the user U of the notification information CI. The notification information CI is information indicating that replacement of the liquid ejecting head 30 having a sign of ink leakage is prompted. For example, it is assumed that the estimation result estimates that the bonding portion GL57 of the liquid ejecting head 30 is deteriorated, that is, it is estimated that there is a sign of ink leakage from the liquid ejecting head 30. On this assumption, the notification information CI is a character string stating “There is a sign that the liquid ejecting head is failing. There is a sign of ink leakage from this liquid ejecting head. Please replace the liquid ejecting head”. Additionally, the notification information CI is not limited to the character string. For example, the notification information CI may be information indicating an image in which a highlighted image that highlights the liquid ejecting head 30 having a sign of ink leakage is superimposed on an image indicating the head module 3. The highlighted image is, for example, an image in which a color of the liquid ejecting head 30 having a sign of ink leakage is made different from a color of the liquid ejecting head 30 having no sign of ink leakage, or an image in which a balloon pointing to the liquid ejecting head 30 having a sign of ink leakage is provided, the balloon including a character string stating “It is recommended to replace this liquid ejecting head”.

In addition, the estimation section 73 may estimate a lifetime of the liquid ejecting head 30 based on the degree of deterioration of the bonding portion GL57 and a period from a date of start of use of the liquid ejecting head 30 to a current date. For example, the storage circuit 22 stores information indicating a date of start of use of the liquid ejecting head 30, information indicating a first period from the start of use of the liquid ejecting head 30 until ink leaks from the fragile bonding portion GLW, the information being obtained by experiments and the like conducted by the head manufacturer, and information indicating a second period from the start of use of the liquid ejecting head 30 until ink leaks from the bonding portion GL57. It is assumed that ink leakage from the fragile bonding portion GLW of the liquid ejecting head 30 is detected. The estimation section 73 calculates the lifetime of the liquid ejecting head 30 by using the following Equation (1).

Lifetime of the liquid ejecting head 30=(Current date−Date of start of use of the liquid ejecting head 30)×(Second period/First period)+Current date (1)

The notification section 75 notifies the user U of lifetime information indicating the lifetime estimated by the estimation section 73, by including the lifetime information in the notification information CI. The lifetime information is, for example, a character string stating “The expected failure date of the liquid ejecting head 30 is yyyy/mm/dd”. yyyy is a four-digit numerical value. mm is an integer from 1 to 12. dd is an integer from 1 to 31. In addition, the notification section 75 may notify the user U of the notification information CI at a time point at which ink leakage from the fragile bonding portion GLW is detected, or may notify the user U of the notification information CI a predetermined number of days before a date indicated by the lifetime information.

After the end of processing in step SC10, the control circuit 21 ends the series of processes shown in FIG. 17. Additionally, when the determination result in step SC8 is negative, the control circuit 21 also ends the series of processes shown in FIG. 17.

When the processing apparatus 200 receives the notification information CI, the control circuit 210 of the processing apparatus 200 notifies the user U of the notification information CI in step SS2. Specifically, the control circuit 210 displays the character string or the image indicated by the notification information CI on the display device 270.

In FIGS. 16 and 17, the control circuit 21 functions as the estimation section 73 and the notification section 75, but the present disclosure is not limited thereto. For example, the control circuit 21 may transmit the residual vibration information NEI to the processing apparatus 200, and the control circuit 210 of the processing apparatus 200 may function as the estimation section 73 and the notification section 75.

### 1-12. Summary of First Embodiment

Hereinafter, a summary of the first embodiment will be described on the assumption that the “first flow path member” is the flow path plate Su5, the “second flow path member” is the case 335, the “first bonding portion” is the bonding portion GL57, the “common liquid chamber” is the first liquid storage chamber Ra, and the “plurality of individual flow paths” are the N individual flow paths RJa.

The liquid ejecting head 30 in the first embodiment includes the 2N nozzles Nz that eject ink, the flow path plate Su5 that defines a part of the flow path SF communicating with the 2N nozzles Nz, the case 335 that defines a part of the flow path SF, the bonding portion GL57 for liquid-tightly coupling a part of the flow path SF of the flow path plate Su5 and a part of the flow path SF of the case 335, and the fragile bonding portion GLW that is a bonding portion GL defining the inner wall of the flow path SF, the fragile bonding portion GLW defining the detection space FA that serves as a space for detecting the degree of deterioration of the bonding portion GL57 and that is partitioned from the flow path SF.

According to the first embodiment, by detecting that the fragile bonding portion GLW deteriorates because of contact with ink and that ink penetrates into the detection space FA, it is possible to estimate the degree of deterioration of the bonding portion GL57. The user U can know a time point at which deterioration of the bonding portion GL57 is detected as an appropriate timing for replacing the liquid ejecting head 30. Additionally, according to the first embodiment, as compared with an aspect in which the degree of deterioration of the bonding portion GL57 is predicted by counting a liquid passing time, it is possible to estimate the degree of deterioration of the bonding portion GL57 with higher accuracy for various inks.

In addition, in the first aspect of the fragile bonding portion GLW, the adhesive forming the fragile bonding portion GLW and the adhesive forming the bonding portion GL57 are of the same type.

Since the adhesive forming the fragile bonding portion GLW and the adhesive forming the bonding portion GL57 are of the same type, it is possible to make deterioration conditions of the fragile bonding portion GLW and the bonding portion GL57 the same for various inks. As a result of being able to make the deterioration conditions the same, according to the first embodiment, as compared with an aspect in which the adhesives are of different types from each other, it is possible to make degrees of progression of deterioration when the fragile bonding portion GLW and the bonding portion GL57 come into contact with ink closer, and to improve accuracy of estimating the degree of deterioration of the bonding portion GL57.

Additionally, in the first aspect of the fragile bonding portion GLW, the ink penetration distance LGW, which is the shortest distance from a portion of the fragile bonding portion GLW that defines the flow path SF to a portion of the fragile bonding portion GLW that defines the detection space FA, is shorter than the ink penetration distance L57, which is the shortest distance from a portion of the bonding portion GL57 that defines the flow path SF to the end portion of the bonding portion GL57 on a side opposite to the portion that defines the flow path SF.

According to the first embodiment, as compared with an aspect in which the ink penetration distance LGW is longer than the ink penetration distance L57, it is possible to detect a sign of ink leakage from the bonding portion GL57 before a time point at which ink leaks from the bonding portion GL57.

In addition, in the second aspect of the fragile bonding portion GLW, the liquid resistance of the fragile bonding portion GLW is lower than the liquid resistance of the bonding portion GL57.

According to the first embodiment, it is possible to detect a sign of ink leakage from the bonding portion GL57 before a time point at which ink leaks from the bonding portion GL57.

Further, the flow path SF includes the N individual flow paths RJa respectively communicating with the N nozzles Nz, and the first liquid storage chamber Ra coupled in common to the N individual flow paths RJa, and the fragile bonding portion GLW partitions at least a part of the dummy individual flow path RJD from the first liquid storage chamber Ra, as the detection space FA.

According to the first embodiment, since at least a part of one or more individual flow paths RJa among the N individual flow paths RJa need only be used as the detection space FA, the detection space FA can be formed only by providing the fragile bonding portion GLW.

Additionally, the liquid ejecting head 30 forms an image by ejecting ink onto the medium PP, the dummy piezoelectric element ED that does not directly contribute to forming the image is further provided, and the dummy individual flow path RJD includes the dummy pressure chamber CD inside which pressure is applied by the dummy piezoelectric element ED.

According to the first embodiment, since a sign of ink leakage from the bonding portion GL57 can be detected by a mechanism that acquires the residual vibration information NEI provided for executing an appropriate cleaning process, it is not necessary to provide a new sensor in order to detect a sign of ink leakage from the bonding portion GL57.

In addition, the ink jet printer 100 includes the liquid ejecting head 30 and the control circuit 21. The control circuit 21 functions as the acquisition section 71 that acquires the residual vibration information NEI which is information regarding the presence or absence of ink in the detection space FA, and the estimation section 73 that estimates the degree of deterioration of the bonding portion GL57 based on the residual vibration information NEI acquired by the acquisition section 71.

According to the first embodiment, the degree of deterioration of the bonding portion GL57 can be estimated. Further, according to the present embodiment, it is possible to detect a sign of ink leakage from the liquid ejecting head 30 without destroying the liquid ejecting head 30.

Further, the control circuit 21 also functions as the notification section 75 that issues a notification prompting the replacement of the liquid ejecting head 30 when the estimation section 73 estimates that the bonding portion GL57 is deteriorated.

According to the first embodiment, the user U can replace the liquid ejecting head 30 before ink leaks from the liquid ejecting head 30 by replacing the liquid ejecting head 30 in response to the notification prompting the replacement of the liquid ejecting head 30.

### 2. SECOND EMBODIMENT

In the first embodiment, the mechanism that acquires the residual vibration information NEI is used and the dummy individual flow path RJD is provided to estimate whether or not the bonding portion GL is deteriorated, but the present disclosure is not limited thereto, and the detection space FA for estimating whether or not the bonding portion GL is deteriorated may be provided separately from the dummy individual flow path RJD. A second embodiment will be described below.

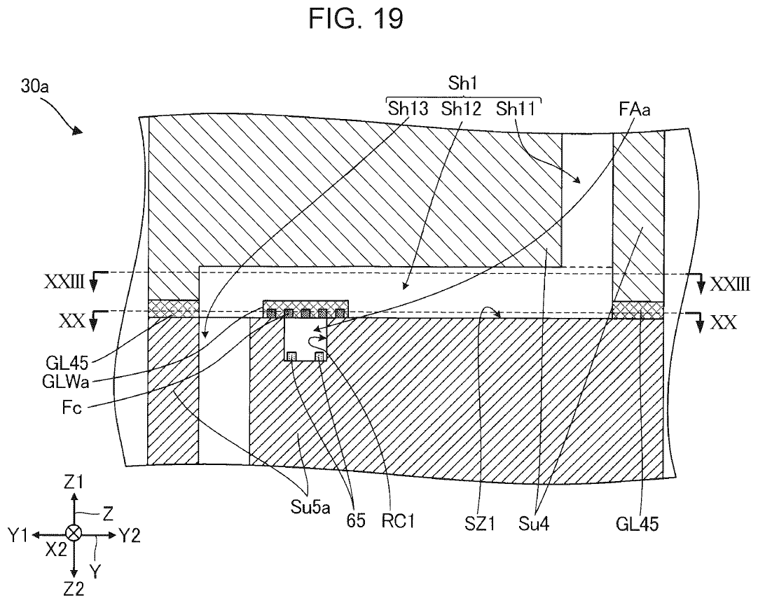

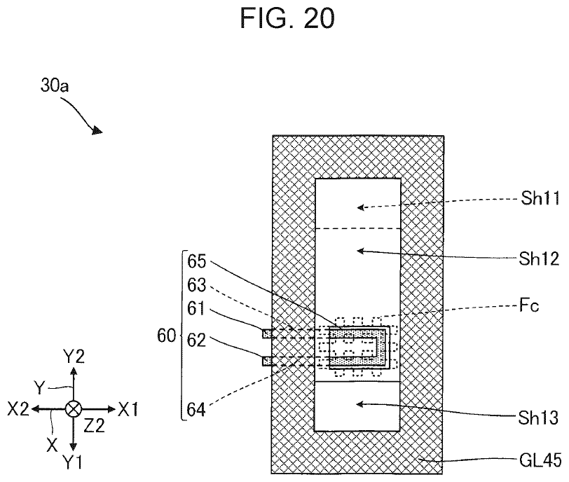

FIG. 18 is a block diagram showing a configuration example of an ink jet printer 100a in the second embodiment. The ink jet printer 100a includes a liquid ejecting head 30a instead of the liquid ejecting head 30, includes a control circuit 21a instead of the control circuit 21, includes a storage circuit 22a instead of the storage circuit 22, and includes a measurement circuit 80 instead of the generation circuit 29. The liquid ejecting head 30a is provided with a detection space FAa instead of the detection space FA. A detection mechanism 60 is provided in the vicinity of the detection space FAa. The detection space FAa will be described with reference to FIGS. 19 and 20.

### 2-1. Detection Space FAa in Second Embodiment

FIGS. 19 and 20 are views illustrating the detection space FAa. FIGS. 19 and 20 show an example in which the detection space FAa is provided in a region RG1 shown in FIG. 12 after the liquid ejecting head 30 shown in FIG. 12 is replaced with the liquid ejecting head 30a. The region RG1 includes a supply flow path Sh1 that is a part of the in-structure supply flow path S1b and that is formed by the flow path plates Su4 and Su5. Additionally, in the subsequent drawings, in order to prevent the drawings from being complicated, shapes of the flow path structure 33 and the flow paths inside the flow path structure 33 are shown in a simplified manner as appropriate. In FIG. 19, the region RG1 of the liquid ejecting head 30a is shown in an enlarged manner. FIG. 20 shows a cross-section of the liquid ejecting head 30a taken along line XX-XX in FIG. 19.

As shown in FIG. 19, the supply flow path Sh1 includes a vertical flow path Sh11 extending in the direction along the Z-axis, a horizontal flow path Sh12 extending in the direction perpendicular to the Z-axis, and a vertical flow path Sh13 extending in the direction along the Z-axis. In FIG. 20, a position of the vertical flow path Sh11 is shown in order to show a positional relationship. An end portion of the vertical flow path Sh11 in the Z2 direction communicates with an end portion of the horizontal flow path Sh12 in the Y2 direction. An end portion of the horizontal flow path Sh12 in the Y1 direction communicates with an end portion of the vertical flow path Sh13 in the Z1 direction.

The liquid ejecting head 30a includes a flow path plate Su5a instead of the flow path plate Su5. In the flow path plate Su5a, a recessed portion RC1 is provided in a bottom surface SZ1 of the horizontal flow path Sh12. An opening of the recessed portion RC1 is open in the Z1 direction. The Z1 direction is a direction opposite to a direction in which the nozzle Nz is open. The detection space FAa in the second embodiment is defined by a fragile bonding portion GLWa in the second embodiment closing the opening of the recessed portion RC1. In the second embodiment, a filter member Fc is provided to cover the opening of the recessed portion RC1 in order to form a thickness of the fragile bonding portion GLWa to be thin. The fragile bonding portion GLWa is formed to cover the filter member Fc. In the initial state of the liquid ejecting head 30a, since the opening of the recessed portion RC1 is covered with the fragile bonding portion GLWa, the detection space FAa is a sealed space. In FIG. 20, in order to show the inside of the detection space FAa, an outline of the filter member Fc is shown by a broken line. Further, in FIG. 20, in order to prevent the drawing from being complicated, only an outline of the fragile bonding portion GLWa is shown by a broken line. By using the filter member Fc, it is possible to form the thin fragile bonding portion GLWa. The filter member Fc is, for example, integrated with the flow path plate Su5a by insert molding. However, the filter member Fc need not be provided at the opening of the recessed portion RC1.

As shown in FIG. 18, the detection mechanism 60 used to determine whether or not ink is present in the detection space FAa is also provided in the vicinity of the detection space FAa. The detection mechanism 60 includes a detection wiring 61, a detection wiring 62, an in-member wiring 63, an in-member wiring 64, and a detection conductive wire 65. It is possible to detect a sign of ink leakage from the bonding portion GL57 based on a magnitude of a current of the detection conductive wire 65. In the second embodiment, it is assumed that the ink has conductive properties. The ink having conductive properties is, for example, an aqueous ink containing an electrolyte. However, the ink having conductive properties is not limited to the aqueous ink having an electrolyte and may be UV ink having an electrolyte.

The detection conductive wire 65 is disposed on the bottom surface in the detection space FAa. The detection conductive wire 65 has a U shape. The in-member wiring 63 and the in-member wiring 64 penetrate through the flow path plate Su5a from a wall surface defining the X2 direction of the detection space FAa in the direction along the X-axis. An end portion of the in-member wiring 63 in the X1 direction is coupled to one end of the detection conductive wire 65. An end portion of the in-member wiring 64 in the X1 direction is coupled to the other end of the detection conductive wire 65. An end portion of the in-member wiring 63 in the X2 direction is coupled to the detection wiring 61. An end portion of the in-member wiring 64 in the X2 direction is coupled to the detection wiring 62. The detection wiring 61 and the detection wiring 62 are coupled to the circuit board 383u or 383v along the side wall of the flow path structure 33. The detection wiring 61 and the detection wiring 62 are coupled to the measurement circuit 80 via the circuit board 383u or 383v. The detection conductive wire 65 is an example of a “conductive wire for detecting the degree of deterioration of the first bonding portion provided in the detection space”.

A method of detecting whether or not ink is present in the detection space FAa by using the detection mechanism 60 will be described. The measurement circuit 80 determines whether or not ink is present in the detection space FAa based on the magnitude of the current between the detection wirings 61 and 62. In contrast to the initial state of the liquid ejecting head 30a in which no ink is present in the detection space FAa, in a state in which the fragile bonding portion GLWa deteriorates and ink is present in the detection space FAa, a part of the detection conductive wire 65 is short-circuited by the ink, and resistance between the detection wirings 61 and 62 decreases. Therefore, a current value between the detection wirings 61 and 62 in a state in which ink is present in the detection space FAa is greater than a current value between the detection wirings 61 and 62 in a state in which no ink is present in the detection space FAa. Accordingly, the measurement circuit 80 measures the current value between the detection wirings 61 and 62 as a measurement process. The measurement circuit 80 generates measurement information JI indicating the measured current value and transmits the measurement information JI to the control circuit 21a. The measurement information JI indicating the current value between the detection wirings 61 and 62 can be said to be information regarding the presence or absence of ink in the detection space FAa.

### 2-2. Operation of Second Embodiment

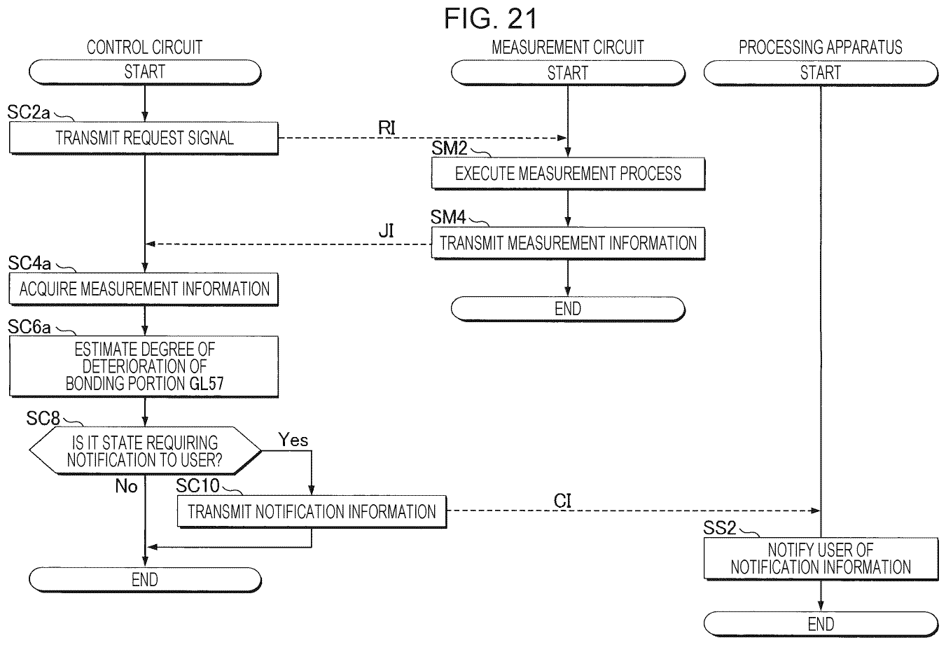

FIG. 21 is a flowchart showing an operation of the ink jet system SYS in the second embodiment. The control circuit 21a functions as an acquisition section 71a, an estimation section 73a, and the notification section 75 by executing a control program PM2a read from the storage circuit 22a. Hereinafter, only differences from FIG. 17 will be described.

In step SC2a, the control circuit 21a transmits the request signal RI to the measurement circuit 80. After the end of processing in step SC2a, the control circuit 21a waits for a response from the measurement circuit 80.

When the measurement circuit 80 receives the request signal RI, the measurement circuit 80 executes the measurement process in step SM2. After the end of processing in step SM2, the measurement circuit 80 transmits the measurement information JI indicating a measurement result to the control circuit 21a in step SM4. After the end of processing in step SM4, the measurement circuit 80 ends a series of processes shown in FIG. 21.

The control circuit 21a functions as the acquisition section 71a to acquire the measurement information JI from the measurement circuit 80 in step SC4a. Next, the control circuit 21a functions as the estimation section 73a to estimate the degree of deterioration of the bonding portion GL57 based on the measurement information JI in step SC6a. Specifically, in order to estimate the degree of deterioration of the bonding portion GL57, the storage circuit 22a stores a threshold value of a current value when ink can be regarded as being present in the detection space FAa. Then, when the current value between the detection wirings 61 and 62 is greater than the threshold value, the control circuit 21a estimates that the bonding portion GL57 is deteriorated because ink is present in the detection space FAa.

### 2-3. Summary of Second Embodiment

As described above, according to the second embodiment, the ink flowing through the supply flow path Sh1 has conductive properties, and the detection conductive wire 65 for detecting the degree of deterioration of the bonding portion GL57 is disposed in the detection space FAa.

According to the second embodiment, the degree of deterioration of the bonding portion GL57 can be estimated using a change in electrical resistance of the detection conductive wire 65 caused by contact of the detection conductive wire 65 with ink.

In addition, the detection space FAa in the second embodiment is a sealed space.

In a case where the detection space FA is not a sealed space as in the first embodiment, when the fragile bonding portion GLW deteriorates and ink is present in the detection space FA, ink may leak from the detection space FA to the outside of the liquid ejecting head 30 before the ink leaks from the bonding portion GL. Therefore, according to the second embodiment, even when the fragile bonding portion GLWa deteriorates and ink is present in the detection space FAa, it is possible to suppress ink leakage from the detection space FAa to the outside of the liquid ejecting head 30a.

Additionally, the detection space FAa is defined by the fragile bonding portion GLWa closing the opening of the recessed portion RC1 provided in the bottom surface SZ1 defining the supply flow path Sh1, and the opening of the recessed portion RC1 is open in a direction opposite to the direction in which the nozzle Nz is open.

In an aspect in which the detection space FAa is provided in a surface facing the bottom surface SZ1, air present in the detection space FAa in the initial state of the liquid ejecting head 30a is not discharged to the supply flow path Sh1, and ink may not come into contact with the detection conductive wire 65. On the other hand, in the second embodiment, since the fragile bonding portion GLWa is provided to cover the recessed portion RC1 formed in the bottom surface SZ1, when the fragile bonding portion GLWa collapses, air present in the detection space FAa is easily discharged by buoyancy, and ink can be more easily brought into contact with the detection conductive wire 65. As a result, it is possible to suppress erroneous detection that no ink is present in the detection space FAa even though ink is present in the detection space FAa.

However, the detection space FAa is formed by the fragile bonding portion GLWa closing the opening of the recessed portion RC1 provided in the bottom surface SZ1, but the present disclosure is not limited thereto. For example, the detection space FAa may be formed by a recessed portion provided in a side surface or an upper surface that defines the supply flow path Sh1, and the fragile bonding portion GLWa closing the opening of the recessed portion.

In addition, the control circuit 21a in the second embodiment functions as the acquisition section 71a that acquires the measurement information JI that is the information regarding the presence or absence of ink in the detection space FAa, and the estimation section 73a that estimates the degree of deterioration of the bonding portion GL57 based on the measurement information JI acquired by the acquisition section 71a. Further, the control circuit 21a may function as the notification section 75.

According to the second embodiment, it is also possible to notify the user U that there is a sign of ink leakage in the liquid ejecting head 30a by using a change in resistance of the detection conductive wire 65 caused by contact of the detection conductive wire 65 with ink.

### 3. THIRD EMBODIMENT

In a third embodiment, a configuration is employed in which ink in the detection space FA can be directly visually recognized. The third embodiment will be described below.

### 3-1. Configuration and Operation of Third Embodiment

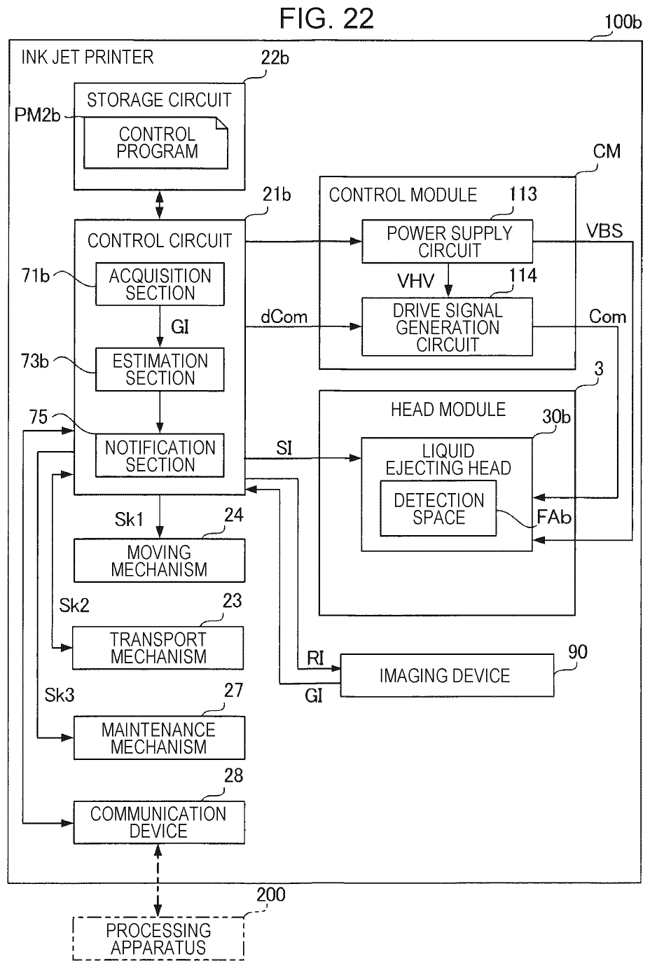

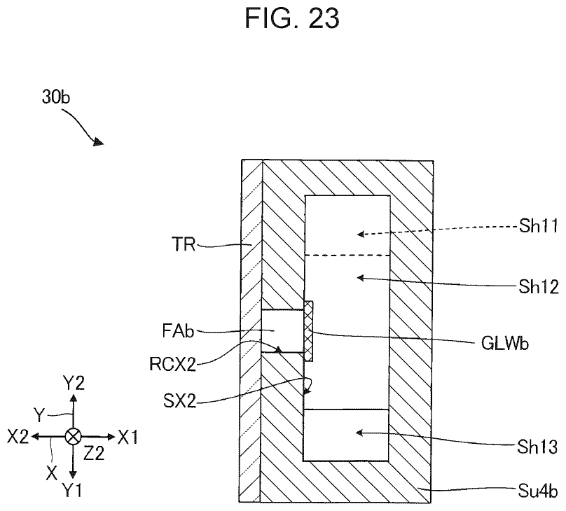

FIG. 22 is a block diagram showing a configuration example of an ink jet printer 100b in the third embodiment. The ink jet printer 100b includes a liquid ejecting head 30b instead of the liquid ejecting head 30, includes a control circuit 21b instead of the control circuit 21, includes a storage circuit 22b instead of the storage circuit 22, and includes an imaging device 90 instead of the generation circuit 29. The liquid ejecting head 30b is provided with a detection space FAb instead of the detection space FA. The detection space FAb will be described with reference to FIG. 23.

FIG. 23 is a view illustrating the detection space FAb. FIG. 23 shows a cross-section of the liquid ejecting head 30b taken along line XXIII-XXIII shown in FIG. 19 after the liquid ejecting head 30a shown in FIG. 19 is replaced with the liquid ejecting head 30b.

The liquid ejecting head 30b includes a flow path plate Su4b instead of the flow path plate Su4. As shown in FIG. 23, the detection space FAb is defined by the flow path plates Su4b and Su5. The detection space FAb is defined by a fragile bonding portion GLWb in the third embodiment closing the opening of a recessed portion RCX2 provided in a side surface SX2 of the horizontal flow path Sh12 in the X2 direction. Similarly to the second embodiment, a filter member may be provided to cover the opening of the recessed portion RCX2, and the fragile bonding portion GLWb may be formed to cover the filter member.

An end portion of the flow path plate Su4b in the X2 direction is formed by a light-transmitting member TR having light-transmitting properties. In the present specification, having light-transmitting properties means that a member having a thickness of 10 mm or less has a visible light transmittance of 50% or greater. However, it is preferable that the transmittance is high, and specifically, it is preferable that a member having a thickness of 10 mm or less has a visible light transmittance of 70% or greater, and more preferably 90% or greater. The member having light-transmitting properties is formed of glass and transparent resin materials such as a transparent epoxy resin and a transparent acrylic resin. In addition, as a method of manufacturing the flow path plate Su4b, for example, the light-transmitting member TR and a non-light-transmitting resin may be integrated by insert molding, or the light-transmitting member TR may be bonded to the non-light-transmitting resin using some kind of adhesive. As shown in FIG. 23, the X2 direction of the detection space FAb is defined by the light-transmitting member TR. The light-transmitting member TR is an example of a “member defining a part of the detection space”.

In the initial state of the liquid ejecting head 30b, as shown in FIG. 23, the fragile bonding portion GLWb closes the opening of the recessed portion RCX2. Therefore, in the initial state of the liquid ejecting head 30b, the detection space FAb is filled with air, and no ink is present. Accordingly, in the initial state of the liquid ejecting head 30b, the detection space FAb is a sealed space. When the fragile bonding portion GLWb deteriorates, ink penetrates into the detection space FAb. Accordingly, by observing a detection mechanism 60Ab through the light-transmitting member TR to confirm whether or not ink is present in the detection space FAb, it is possible to estimate the degree of deterioration of the bonding portion GL57.

When the fragile bonding portion GLWb deteriorates and ink penetrates into the detection space FAb, air present in the detection space FAb may form bubbles and be mixed into the horizontal flow path Sh12. However, by executing a pumping process, which is a type of cleaning process, it is possible to remove bubbles mixed into the horizontal flow path Sh12.

The description returns to FIG. 22. The imaging device 90 images the detection space FAb. The imaging device 90 includes an imaging optical system and an imaging element. The imaging optical system is an optical system including at least one imaging lens, and may include various optical elements such as a prism, or may include a zoom lens, a focus lens, or the like. From the viewpoint that it is easy to image a detection surface with the imaging element, it is preferable that the imaging optical system includes a wide-angle lens or a fisheye lens. The imaging element includes, for example, a charge coupled device (CCD) image sensor, a complementary MOS (CMOS) image sensor, or the like. The imaging element captures an image via the imaging optical system and transmits image information GI indicating the captured image to the control circuit 21b.

In order for the imaging device 90 to be able to image the detection space FAb, a through-hole or a transparent member is provided in a portion of a side wall of the cover member 31 in the X2 direction, the portion overlapping the detection space FAb as viewed in the direction along the X-axis, and the detection space FAb can be visually recognized from the outside of the liquid ejecting head 30b. Additionally, the imaging device 90 may include a light source that irradiates the detection space FAb in order to make the image obtained by capturing the detection space FAb clearer.

The storage circuit 22b stores a control program PM2b instead of the control program PM2. As shown in FIG. 22, the control circuit 21b functions as an acquisition section 71b, an estimation section 73b, and the notification section 75 by executing the read control program PM2b.

### 3-2. Operation of Third Embodiment

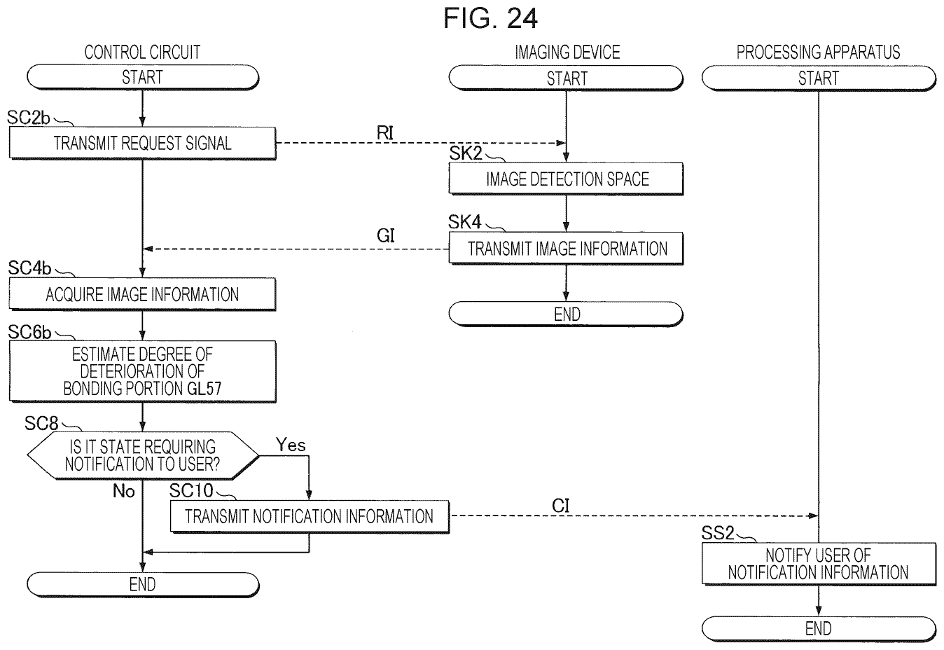

FIG. 24 is a flowchart showing an operation of the ink jet system SYS in the third embodiment. Hereinafter, only differences from the flowchart shown in FIG. 21 will be described.

In step SC2b, the control circuit 21b transmits the request signal RI to the imaging device 90. After the end of processing in step SC2b, the control circuit 21b waits for a response from the imaging device 90.

When the imaging device 90 receives the request signal RI, the imaging device 90 images the detection space FAb in step SK2. Then, in step SK4, the imaging device 90 transmits the image information GI indicating the image obtained by capturing the detection space FAb to the control circuit 21b. After the end of processing in step SK4, the imaging device 90 ends a series of processes shown in FIG. 24.

The control circuit 21b functions as the acquisition section 71b to acquire the image information GI from the imaging device 90 in step SC4b. Next, the control circuit 21b functions as the estimation section 73b to estimate the degree of deterioration of the bonding portion GL57 based on the image information GI in step SC6b. Specifically, the storage circuit 22b stores pre-deterioration image information indicating an image obtained by capturing the detection space FAb in a state in which no ink is present in the detection space FAb, and post-deterioration image information indicating an image obtained by capturing the detection space FAb in a state in which ink is present in the detection space FAb. The estimation section 73b determines whether the image obtained by capturing the detection space FAb is closer to the image indicated by the pre-deterioration image information or to the image indicated by the post-deterioration image information. When it is determined that the image indicated by the image information GI is closer to the image indicated by the pre-deterioration image information, the estimation section 73b estimates that the bonding portion GL57 is not deteriorated. On the other hand, when it is determined that the image indicated by the image information GI is closer to the image indicated by the post-deterioration image information, the estimation section 73b estimates that the bonding portion GL57 is deteriorated. The pre-deterioration image information and the post-deterioration image information are stored in the storage circuit 22b in advance by the head manufacturer based on experiments.

In the third embodiment, the image information GI can be said to be information regarding the presence or absence of ink in the detection space FAb.

### 3-3. Summary of Third Embodiment

As described above, according to the third embodiment, the light-transmitting member TR which is a member defining a part of the detection space FAb has light-transmitting properties.

According to the third embodiment, by making the detection space FAb visually recognizable from the outside, when ink leaks from the fragile bonding portion GLWb, the ink in the detection space FAb can be visually recognized, thereby estimating the degree of deterioration of the bonding portion GL57.

In addition, the control circuit 21b in the third embodiment functions as the acquisition section 71b that acquires the image information GI, which is information regarding the presence or absence of ink in the detection space FAb, and the estimation section 73b that estimates the degree of deterioration of the bonding portion GL57 based on the image information GI acquired by the acquisition section 71b. Further, the control circuit 21b may function as the notification section 75.

According to the third embodiment, by using the fact that ink is present in the detection space FAb when ink leaks from the fragile bonding portion GLWb, it is also possible to notify the user U that there is a sign of ink leakage from the liquid ejecting head 30b.

In the third embodiment, the ink jet printer 100b need not include the imaging device 90. The user U can detect a sign of ink leakage from the liquid ejecting head 30b by directly visually observing the detection space FAb of the liquid ejecting head 30b. Additionally, the liquid ejecting head 30b may include both the detection space FAb for visual observation by the user U and the detection space FAb for imaging by the imaging device 90.

### 4. FOURTH EMBODIMENT

In a fourth embodiment, attention is focused on the fact that when ink penetrates into the detection space FA, the pressure loss of the flow path SF changes, and whether or not the bonding portion GL is deteriorated is estimated. The fourth embodiment will be described below.

### 4-1. Configuration and Operation of Fourth Embodiment

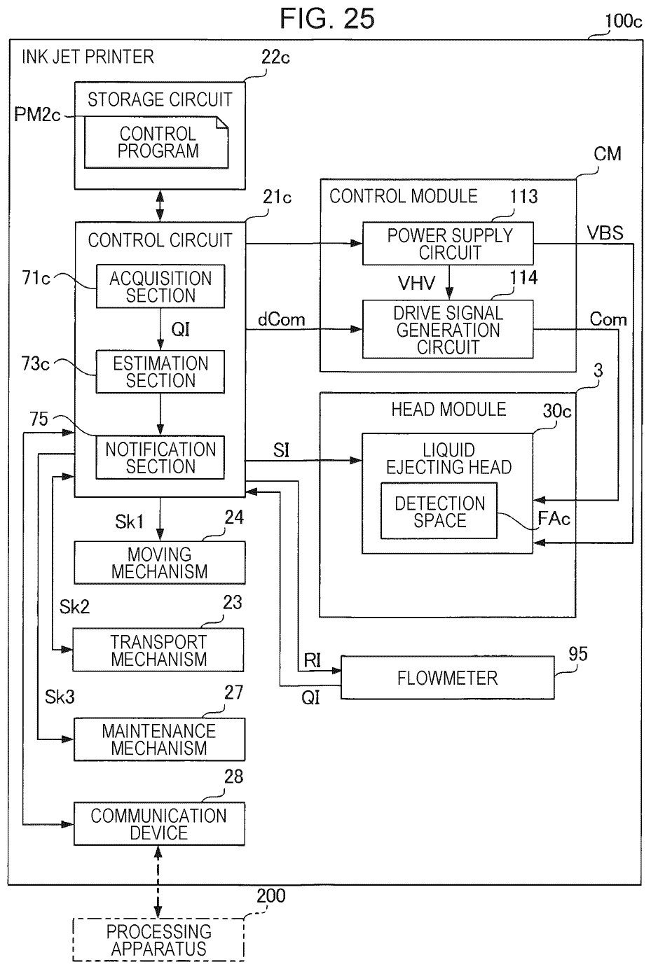

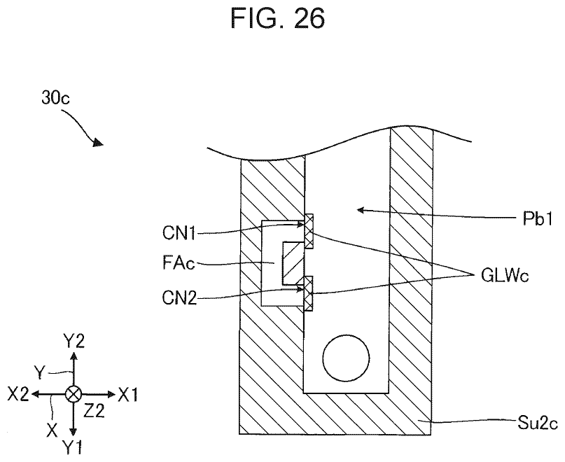

FIG. 25 is a block diagram showing a configuration example of an ink jet printer 100c in the fourth embodiment. The ink jet printer 100c includes a liquid ejecting head 30c instead of the liquid ejecting head 30, includes a control circuit 21c instead of the control circuit 21, includes a storage circuit 22c instead of the storage circuit 22, and includes a flowmeter 95 instead of the generation circuit 29. In the liquid ejecting head 30c, a detection space FAc is provided instead of the detection space FA. The detection space FAc will be described with reference to FIG. 26.

### 4-2. Detection Space FAc in Fourth Embodiment

FIG. 26 is a view illustrating the detection space FAc. FIG. 26 shows a cross-section of the supply portion Pb1 in a region RG2 shown in FIG. 10 in the liquid ejecting head 30c, taken along a plane parallel to the XY plane.

The liquid ejecting head 30c includes a flow path plate Su2c instead of the flow path plate Su2. As understood from FIGS. 10 and 26, the detection space FAc is defined by the flow path plates Su1 and Su2c. The detection space FAc is a bypass flow path that branches from a first coupling portion CN1 of the supply portion Pb1 and that merges with the supply portion Pb1 at a second coupling portion CN2 different from the first coupling portion CN1 of the supply portion Pb1. The detection space FAc is positioned in the X2 direction with respect to the supply portion Pb1. In the fourth embodiment, the supply portion Pb1 is an example of a “flow path”.

The detection space FAc is defined by a fragile bonding portion GLWc in the fourth embodiment closing the first coupling portion CN1 and the second coupling portion CN2. Similarly to the second embodiment, a filter member may be provided to cover the first coupling portion CN1 and the second coupling portion CN2, and the fragile bonding portion GLWc may be formed to cover the filter member.

In the initial state of the liquid ejecting head 30c, as shown in FIG. 26, the fragile bonding portion GLWc closes the first coupling portion CN1 and the second coupling portion CN2. Therefore, in the initial state of the liquid ejecting head 30c, the detection space FAc is filled with air, and no ink is present. Accordingly, in the initial state of the liquid ejecting head 30c, the detection space FAc is a sealed space. When the printing process is repeatedly performed, foreign matter is captured by the filter portion Fa, so that the flow path resistance continues to increase. When the fragile bonding portion GLWc deteriorates and ink penetrates into the detection space FAc, the detection space FAc functions as the bypass flow path. When the detection space FAc functions as the bypass flow path, the flow path resistance decreases. Then, by repeatedly performing the printing process again, the flow path resistance increases. In general, when the flow path resistance increases, a flow rate value decreases. Accordingly, in the fourth embodiment, by periodically measuring the flow rate value using the flowmeter 95 and detecting that the flow rate value is increased, that is, that the flow path resistance is decreased, it is possible to detect that ink is present in the detection space FAc.

The description returns to FIG. 25. The flowmeter 95 measures the flow rate value of the flow path SF. For example, the flowmeter 95 is provided in the middle of the supply tube Ta_in or in the middle of the discharge tube Ta_out. In addition, in the example of FIG. 25, the flowmeter 95 is provided outside the liquid ejecting head 30c, but the flowmeter 95 may be provided inside the liquid ejecting head 30c. The flowmeter 95 generates flow rate information QI indicating the measured flow rate value and transmits the flow rate information QI to the control circuit 21c. The flow rate information QI can be said to be information regarding the presence or absence of ink in the detection space FAc.

### 4-3. Operation of Fourth Embodiment

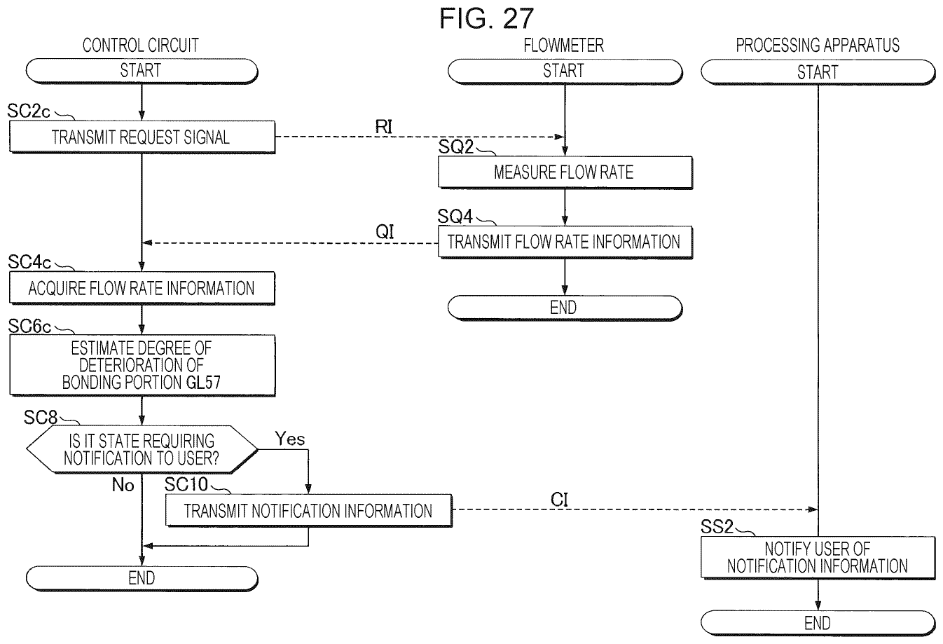

FIG. 27 is a flowchart showing an operation of the ink jet system SYS in the fourth embodiment. The control circuit 21c functions as an acquisition section 71c, an estimation section 73c, and the notification section 75 by executing a control program PM2c read from the storage circuit 22c. Hereinafter, only differences from the flowchart shown in FIG. 17 will be described.

In step SC2c, the control circuit 21c transmits the request signal RI to the flowmeter 95. After the end of processing in step SC2c, the control circuit 21c waits for a response from the flowmeter 95.

When the flowmeter 95 receives the request signal RI, the flowmeter 95 measures the flow rate of the flow path SF in step SQ2. Then, the flowmeter 95 transmits the flow rate information QI to the control circuit 21c in step SQ4. After the end of processing in step SQ4, the flowmeter 95 ends a series of processes shown in FIG. 27.

The control circuit 21c functions as the acquisition section 71c to acquire the flow rate information QI from the flowmeter 95 in step SC4c. Next, the control circuit 21c functions as the estimation section 73c to estimate the degree of deterioration of the bonding portion GL57 based on the flow rate information QI in step SC6c. Specifically, the estimation section 73c stores the flow rate information QI acquired by the acquisition section 71c in the storage circuit 22c. For simplification of description, the flow rate value previously stored in the storage circuit 22c may be referred to as a “previous flow rate value”, and the flow rate value included in the flow rate information QI acquired by the acquisition section 71c may be referred to as a “current flow rate value”. The estimation section 73c determines whether or not the current flow rate value is greater than a value obtained by adding a predetermined value to the previous flow rate value. When the current flow rate value is less than the value obtained by adding the predetermined value to the previous flow rate value, the estimation section 73c estimates that the bonding portion GL57 is not deteriorated. On the other hand, when the current flow rate value is equal to or greater than the value obtained by adding the predetermined value to the previous flow rate value, the estimation section 73c estimates that the bonding portion GL57 is deteriorated. The predetermined value is a value based on value at which the flow rate increases when the detection space FAc functions as the bypass flow path. The predetermined value is stored in the storage circuit 22c in advance by the head manufacturer based on experiments or experience.

In the fourth embodiment, the flow rate information QI can be said to be information regarding the presence or absence of ink in the detection space FAc.

### 4-4. Summary of Fourth Embodiment

As described above, in the fourth embodiment, the detection space FAc is a bypass flow path that branches from the first coupling portion CN1 of the supply portion Pb1 and that merges with the supply portion Pb1 at the second coupling portion CN2 different from the first coupling portion CN1 of the supply portion Pb1, and the fragile bonding portion GLWc closes the first coupling portion CN1 and the second coupling portion CN2.

According to the fourth embodiment, it is possible to detect a sign of ink leakage from the bonding portion GL57 by using the flow path resistance that changes based on the opening of the detection space FAc serving as the bypass flow path. Additionally, according to the fourth embodiment, since it is possible to detect a change in flow path resistance using the flowmeter 95, a new sensor need not be provided in the vicinity of the detection space FAc in order to detect a sign of ink leakage from the bonding portion GL57.

In addition, the control circuit 21c in the fourth embodiment functions as the acquisition section 71c that acquires the flow rate information QI, which is information regarding the presence or absence of ink in the detection space FAc, and the estimation section 73c that estimates the degree of deterioration of the bonding portion GL57 based on the flow rate information QI acquired by the acquisition section 71c. Further, the control circuit 21c may function as the notification section 75.

In the fourth embodiment, the detection space FAc serves as the bypass flow path by being opened, but the detection space FAc need not be the bypass flow path and may, for example, be formed by covering an opening of a recessed portion provided in the side surface of the supply portion Pb1 with the fragile bonding portion GLW, as in the third embodiment. However, in order for the flowmeter 95 to detect the change in flow path resistance, it is necessary to set the detection space FA to have a space of a certain size or greater, and it may be difficult to cover a space of a certain size or greater with the fragile bonding portion GLW. On the other hand, when the detection space FAc is the bypass flow path, a space of a certain size or greater can be formed as the detection space FAc by covering an inlet and an outlet of the bypass flow path with the fragile bonding portion GLW. Additionally, in the third embodiment, the detection space FAb is formed by covering the opening of the recessed portion provided in the side surface of the supply portion Pb1 with the fragile bonding portion GLW. However, as in the fourth embodiment, the detection space FAb may be formed such that the detection space FAb serves as the bypass flow path by being opened.

In the fourth embodiment, the ink jet printer 100c includes the flowmeter 95, but may include a pressure gauge instead of the flowmeter 95. The change in flow path resistance can also be detected by the pressure gauge.

### 5. FIFTH EMBODIMENT

In a fifth embodiment, a part of an annular bonding portion GL for sealing the flow path that suppresses leakage of ink in the flow path SF to the outside is formed as the fragile bonding portion GLW. In addition, in the fifth embodiment, it is possible to detect a sign of ink leakage from the liquid ejecting head 30 in multiple stages. The fifth embodiment will be described below.

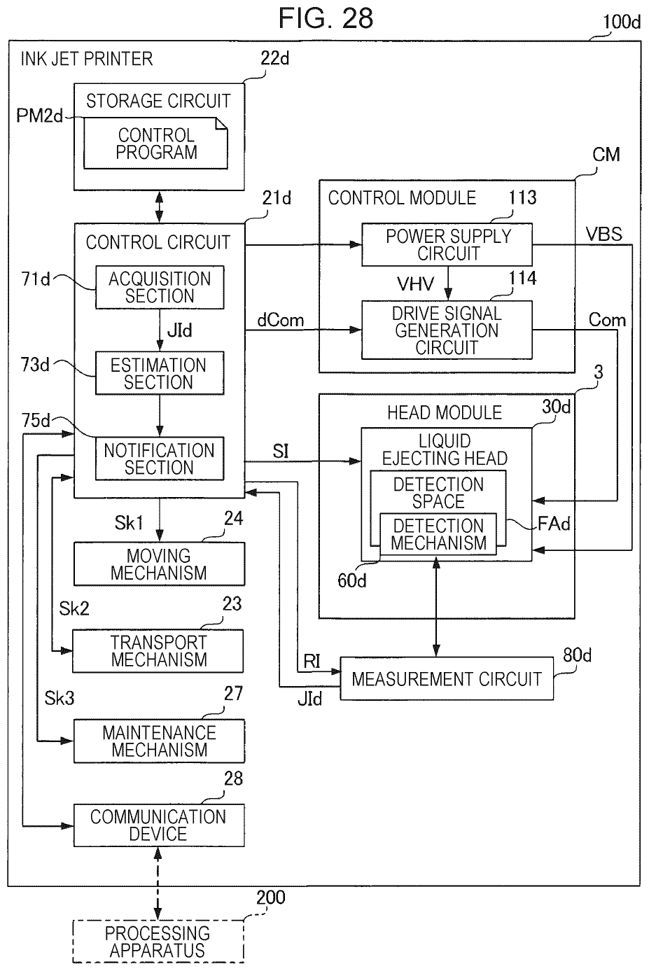

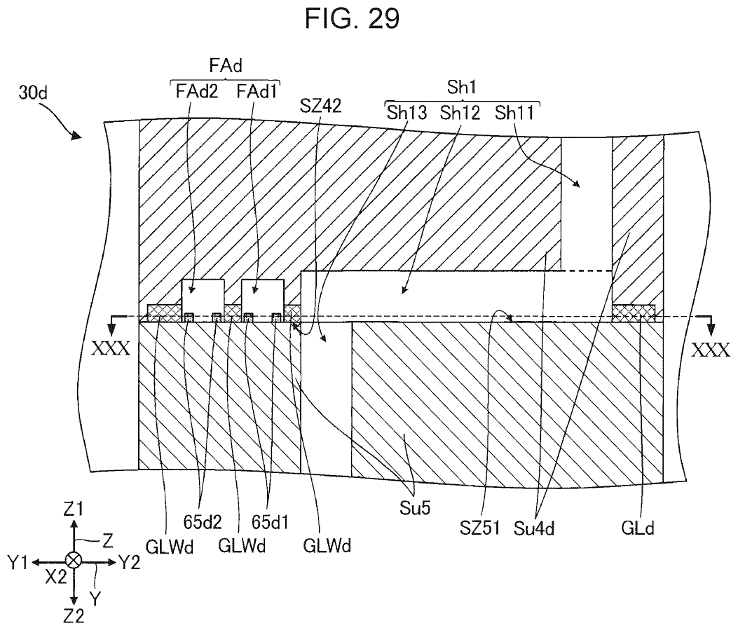

FIG. 28 is a block diagram showing a configuration example of an ink jet printer 100d in the fifth embodiment. The ink jet printer 100d includes a liquid ejecting head 30d instead of the liquid ejecting head 30a, includes a control circuit 21d instead of the control circuit 21a, includes a storage circuit 22d instead of the storage circuit 22a, and includes a measurement circuit 80d instead of the measurement circuit 80. The liquid ejecting head 30d is provided with a detection space FAd instead of the detection space FAa. The detection space FAd will be described with reference to FIGS. 28 and 29.

### 5-1. Detection Space FAd in Fifth Embodiment

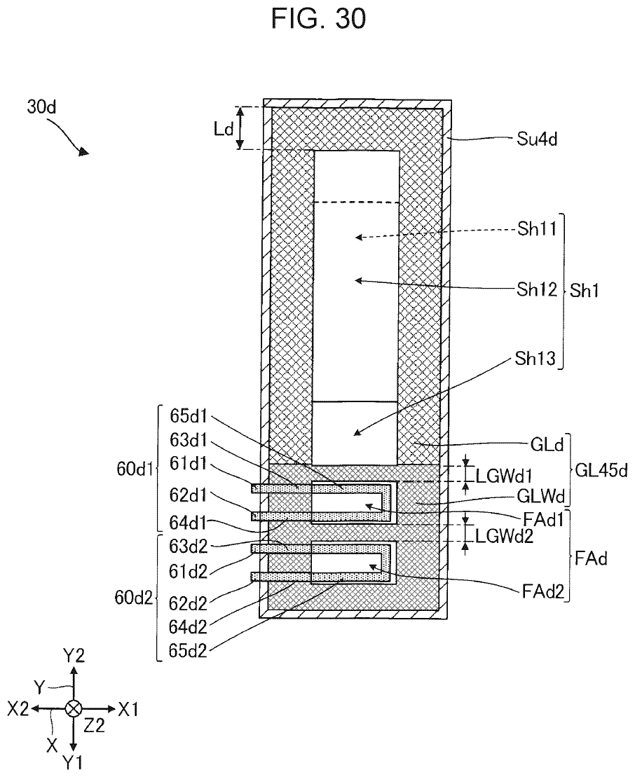

FIGS. 29 and 30 are views illustrating the detection space FAd. In FIGS. 29 and 30, an example is shown in which the detection space FAd is provided in the region RG1 shown in FIG. 12 after the liquid ejecting head 30 shown in FIG. 12 is replaced with the liquid ejecting head 30d. In FIG. 29, the region RG1 of the liquid ejecting head 30d is shown in an enlarged manner. FIG. 30 shows a cross-section of the liquid ejecting head 30d taken along line XXX-XXX shown in FIG. 29.

In the fifth embodiment, the detection space FAd includes a first detection space FAd1 and a second detection space FAd2. As shown in FIG. 28, a detection mechanism 60d used to determine whether or not ink is present in the detection space FAd is also provided in the vicinity of the detection space FAd. The detection mechanism 60d includes a detection mechanism 60d1 used to determine whether or not ink is present in the first detection space FAd1, and a detection mechanism 60d2 used to determine whether or not ink is present in the second detection space FAd2. In the following description, a subscript “1” is added to reference numerals of elements related to the detection mechanism 60d1, and a subscript “2” is added to reference numerals of elements related to the detection mechanism 60d2. In plan view, the elements related to the detection mechanism 60d2 have a structure that substantially coincides with the elements related to the detection mechanism 60d1 when the elements related to the detection mechanism 60d1 are moved in the Y1 direction. Therefore, in the following description, the elements related to the detection mechanism 60d1 will be mainly described, and the description of the elements related to the detection mechanism 60d2 will be omitted as appropriate.

The detection mechanism 60d1 includes detection wirings 61d1 and 62d1, lead-out wirings 63d1 and 64d1, and a detection conductive wire 65d1. It is possible to detect a sign of ink leakage from the bonding portion GL57 based on the magnitude of the current of the detection conductive wire 65d1. In the fifth embodiment, it is assumed that the ink has conductive properties, similarly to the second embodiment.

The lead-out wiring 63d1, the lead-out wiring 64d1, and the detection conductive wire 65d1 are disposed on a surface SZ51 of the flow path plate Su5 that faces the Z1 direction. In plan view, the detection conductive wire 65d1 is disposed in the first detection space FAd1, and the lead-out wirings 63d1 and 64d1 are disposed outside the first detection space FAd1. The detection conductive wire 65d1 has a U shape. The lead-out wirings 63d1 and 64d1 are disposed along the X-axis. An end portion of the lead-out wiring 63d1 in the X1 direction is coupled to one end of the detection conductive wire 65d1. An end portion of the lead-out wiring 64d1 in the X1 direction is coupled to the other end of the detection conductive wire 65d1. An end portion of the lead-out wiring 63d1 in the X2 direction is coupled to the detection wiring 61d1. An end portion of the lead-out wiring 64d1 in the X2 direction is coupled to the detection wiring 62d1. The detection wirings 61d1 and 62d1 are coupled to the measurement circuit 80d via a wiring member (not shown).

The liquid ejecting head 30d includes a flow path plate Su4d instead of the flow path plate Su4. In the flow path plate Su4d, the first detection space FAd1 and the second detection space FAd2 are formed by cutting out, in the Z1 direction, a surface SZ42 of the flow path plate Su4d that faces the Z2 direction.

The horizontal flow path Sh12 is surrounded by a bonding portion GL45d in the fifth embodiment. In plan view, the bonding portion GL45d has an annular shape. In plan view, a part of the bonding portion GL45d is formed by a bonding portion GLd, and a remaining portion of the bonding portion GL45d is formed by a fragile bonding portion GLWd. The fifth embodiment is an aspect in which a sign of ink leakage from the bonding portion GLd is detected. In the examples of FIGS. 29 and 30, the X2 direction, the X1 direction, and the Y2 direction of the horizontal flow path Sh12 are defined by the bonding portion GLd, and the Y1 direction of the horizontal flow path Sh12 is defined by the fragile bonding portion GLWd.

In the examples of FIGS. 29 and 30, an aspect in which the fragile bonding portion GLWd is intentionally made more likely to deteriorate than the bonding portion GLd is, in the fifth embodiment, an aspect similar to the first aspect of the fragile bonding portion GLW described in the first embodiment. However, in the fifth embodiment, in order to detect a sign of ink leakage from the liquid ejecting head 30d in multiple stages, it is necessary that ink is present in the first detection space FAd1 before ink leaks from the bonding portion GLd, and further, that ink is present in the second detection space FAd2. Therefore, the adhesive forming the fragile bonding portion GLWd and the adhesive forming the bonding portion GLd are of the same type, and a sum of a shortest distance LGWd1 and a shortest distance LGWd2 is shorter than an ink penetration distance Ld of the bonding portion GLd. The shortest distance LGWd1 is a shortest distance from a portion where the fragile bonding portion GLWd defines the horizontal flow path Sh12 to an end of the first detection space FAd1 in the Y2 direction. The shortest distance LGWd2 is a shortest distance from an end of the first detection space FAd1 in the Y1 direction to an end of the second detection space FAd2 in the Y2 direction. However, as an aspect in which the fragile bonding portion GLWd is intentionally made more likely to deteriorate than the bonding portion GLd, it is also possible to employ an aspect similar to the second aspect of the fragile bonding portion GLW described in the first embodiment. In the fifth embodiment, the flow path plate Su4d corresponds to a “first flow path member”, the flow path plate Su5 corresponds to a “second flow path member”, the horizontal flow path Sh12 corresponds to a “part of the flow path”, the bonding portion GLd corresponds to a “first bonding portion”, and the fragile bonding portion GLWd corresponds to a “second bonding portion”.

The description returns to FIG. 28. The measurement circuit 80d measures the current value between the detection wirings 61d1 and 62d1 of the detection mechanism 60d1 and the current value between the detection wirings 61d2 and 62d2 of the detection mechanism 60d2 as the measurement process in the fifth embodiment. The measurement circuit 80d transmits measurement information JId indicating the measurement result to the control circuit 21d.

### 5-2. Operation of Fifth Embodiment

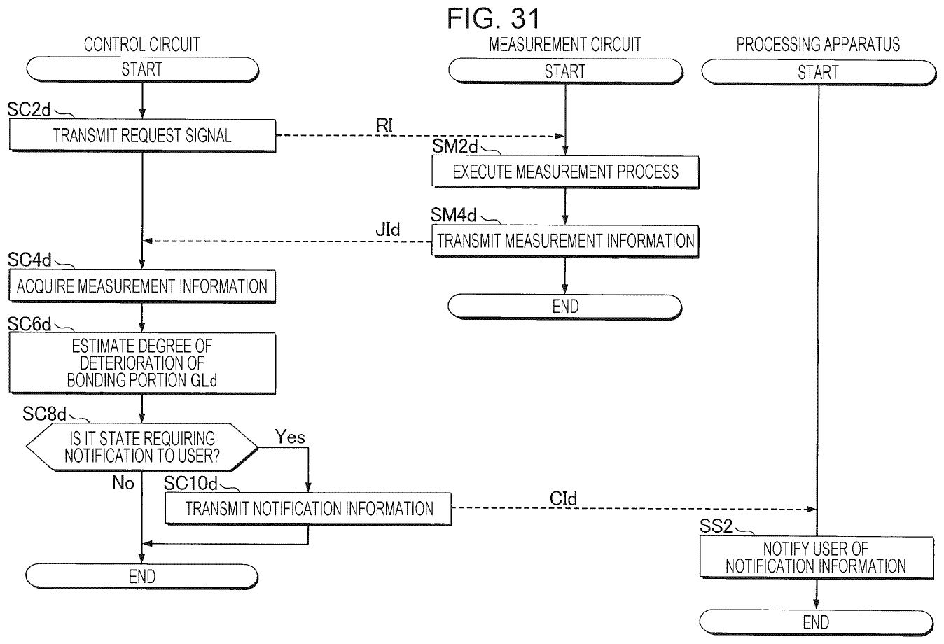

FIG. 31 is a flowchart showing an operation of the ink jet system SYS in the fifth embodiment. The control circuit 21d functions as an acquisition section 71d, an estimation section 73d, and a notification section 75d by executing a control program PM2d read from a storage circuit 22d. Hereinafter, only differences from FIG. 21 will be described.

In step SC2d, the control circuit 21d transmits the request signal RI to the measurement circuit 80d. After the end of processing in step SC2d, the control circuit 21d waits for a response from the measurement circuit 80d.

When the measurement circuit 80d receives the request signal RI, the measurement circuit 80d executes the measurement process in the fifth embodiment in step SM2d. After the end of processing in step SM2d, the measurement circuit 80d transmits the measurement information JId indicating the measurement result to the control circuit 21d in step SM4d. After the end of processing in step SM4d, the measurement circuit 80d ends a series of processes shown in FIG. 31.

The control circuit 21d functions as the acquisition section 71d to acquire the measurement information JId from the measurement circuit 80 in step SC4d. Next, the control circuit 21d functions as the estimation section 73d to estimate the degree of deterioration of the bonding portion GLd based on the measurement information JId in step SC6d. In order to estimate the degree of deterioration of the bonding portion GLd, the storage circuit 22d stores a threshold value of the current value when ink can be regarded as being present in the detection space FAd. In the fifth embodiment, the estimation section 73d estimates the degree of deterioration of the bonding portion GLd in three stages. The estimation section 73d generates stage information indicating any one of the three stages indicating the degree of deterioration of the bonding portion GLd. The stage information is any one of first stage information indicating that the bonding portion GLd is not deteriorated, second stage information indicating that the bonding portion GLd is deteriorated, and third stage information indicating that the bonding portion GLd is deteriorated and the ink is about to leak. The estimation section 73d generates the first stage information when the current value between the detection wirings 61d1 and 62d1 is equal to or less than the threshold value. In addition, the estimation section 73d generates the second stage information when the current value between the detection wirings 61d1 and 62d1 is greater than the threshold value and the current value between the detection wirings 61d2 and 62d2 is equal to or less than the threshold value. Further, the estimation section 73d generates the third stage information when the current value between the detection wirings 61d2 and 62d2 is greater than the threshold value. The estimation section 73d estimates the degree of deterioration of the bonding portion GLd and generates the stage information.

After the end of processing in step SC6d, the control circuit 21d determines in step SC8d whether or not it is a state requiring a notification to the user U, based on the estimation result. More specifically, when the second stage information or the third stage information is present in the stage information, the control circuit 21d determines that it is a state requiring a notification to the user U.

When the determination result in step SC8d is affirmative, the control circuit 21d functions as the notification section 75d to generate notification information CId based on the estimation result and notify the user U of the generated notification information CId, in step SC10d. Specifically, the control circuit 21d transmits the notification information CId to the processing apparatus 200 and causes the processing apparatus 200 to notify the user U of the notification information CId. The notification information CId is information indicating the degree of a sign of ink leakage from the liquid ejecting head 30d. For example, when the second stage information is associated with the liquid ejecting head 30d, the notification information CId is a first sign character string stating “There is a sign of ink leakage in the liquid ejecting head. Please consider replacing the liquid ejecting head”. In addition, when the third stage information is associated with the liquid ejecting head 30d, the notification information CId is a second sign character string stating “The sign of ink leakage from the liquid ejecting head is increased. It is recommended to replace the liquid ejecting head”.

### 5-3. Summary of Fifth Embodiment

As described above, in the fifth embodiment, as viewed in the direction along the Z-axis, which is the lamination direction of the flow path plates Su4d and Su5, the supply flow path Sh1 is surrounded by the bonding portion GL45d, which is the annular bonding portion, and as viewed in the direction along the Z-axis, a part of the bonding portion GL45d is formed by the bonding portion GLd, and the remaining portion of the bonding portion GL45d is formed by the fragile bonding portion GLWd.

According to the fifth embodiment, it is easier to form a thin fragile bonding portion GLWd, as compared with the fragile bonding portion GLW of the first to fourth embodiments. Specifically, the fragile bonding portion GLW of the first to fifth embodiments is layered, one surface of the fragile bonding portion GLW of the first to fourth embodiments defines a part of the flow path SF, and the other surface defines the detection space FA. That is, substantially the entire region of both surfaces of the fragile bonding portion GLW of the first to fourth embodiments is not in contact with the flow path member constituting the flow path SF in the liquid ejecting head 30. Therefore, in order to easily form the thin fragile bonding portion GLW, it is necessary to provide the filter member Fc as in the second embodiment. On the other hand, both surfaces of the fragile bonding portion GLWd in the fifth embodiment are in contact with the flow path member constituting the flow path SF, and the thin fragile bonding portion GLW can be easily formed even without providing the filter member Fc.

In addition, in the fifth embodiment, a sign of ink leakage from the liquid ejecting head 30d can be detected in multiple stages. The user U can take measures corresponding to the notification information CId. Specifically, the user U can use the liquid ejecting head 30d until immediately before the liquid ejecting head 30d fails, while securing a period of time for preparing a replacement liquid ejecting head 30d. For example, when the user U is notified of the first sign character string as the notification information CId, the user U orders the liquid ejecting head 30d from the head manufacturer. Then, when the user U is notified of the second sign character string as the notification information CId, the user U replaces the liquid ejecting head 30d with the liquid ejecting head 30d acquired from the head manufacturer.

In each aspect from the first to the fourth embodiments, it is possible to detect a sign of ink leakage from the liquid ejecting head 30 in multiple stages. For example, in the first embodiment, by providing a plurality of dummy individual flow paths RJD and making the thicknesses of the fragile bonding portions GLW defining the respective dummy individual flow paths RJD different, it is possible to detect a sign of ink leakage from the liquid ejecting head 30 in multiple stages. Similarly, in the second embodiment, by providing a plurality of detection spaces FAa in the liquid ejecting head 30a and making the thicknesses of the fragile bonding portions GLWa that close the respective detection spaces FAa different, it is possible to detect a sign of ink leakage from the liquid ejecting head 30a in multiple stages. The third and fourth embodiments are also similar to the second embodiment.

### 6. MODIFICATION EXAMPLES

Each of the aspects exemplified above can be variously modified. Specific modification aspects that can be applied to each of the aspects mentioned above will be exemplified below. Two or more aspects optionally selected from the following examples can be combined as appropriate within a range in which the aspects are not mutually contradictory.

### 6-1. First Modification Example

In each of the aspects mentioned above, the first ink supplied to the liquid ejecting head 30 flows in the order of the in-structure supply flow path S1a, the in-head supply flow path R1a, the first liquid storage chamber Ra, the in-head discharge flow path R2a, and the in-structure discharge flow path S2a, and is discharged from the liquid ejecting head 30. That is, in each of the aspects mentioned above, the individual flow path RJ is not included in the path through which the ink circulates. However, the present disclosure can also be applied to an aspect in which the individual flow path RJ is included in the path through which the ink circulates. A first modification example will be described below.

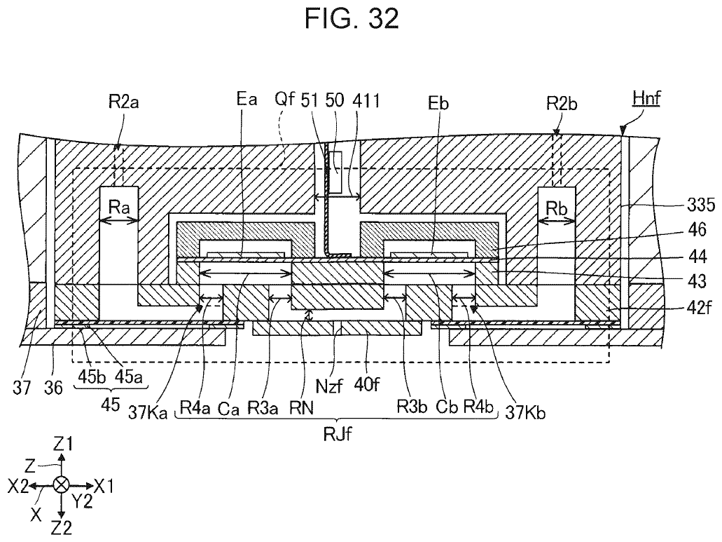

FIG. 32 is a cross-sectional view of a head unit Hnf in the first modification example, taken in section. The head unit Hn includes N nozzles Nz that eject the first ink and N nozzles Nz that eject the second ink, but the head unit Hnf includes Nf nozzles Nzf that eject the first ink. Nf is an integer of 1 or greater. The head unit Hnf includes a liquid ejecting portion Qf that ejects the first ink. The head unit Hnf includes a nozzle plate 40f instead of the nozzle plate 40, and includes a communication plate 42f instead of the communication plate 42.

The nozzle plate 40f is formed with the Nf nozzles Nzf. The Nf nozzles Nzf provided in the nozzle plate 40f are disposed along one nozzle row along the Y-axis. The communication plate 42f is further provided with a nozzle flow path RN through which the first communication flow path R3a communicates with a first communication flow path R3b. The nozzle flow path RN is a space extending along the X-axis. One nozzle flow path RN includes one nozzle Nzf.

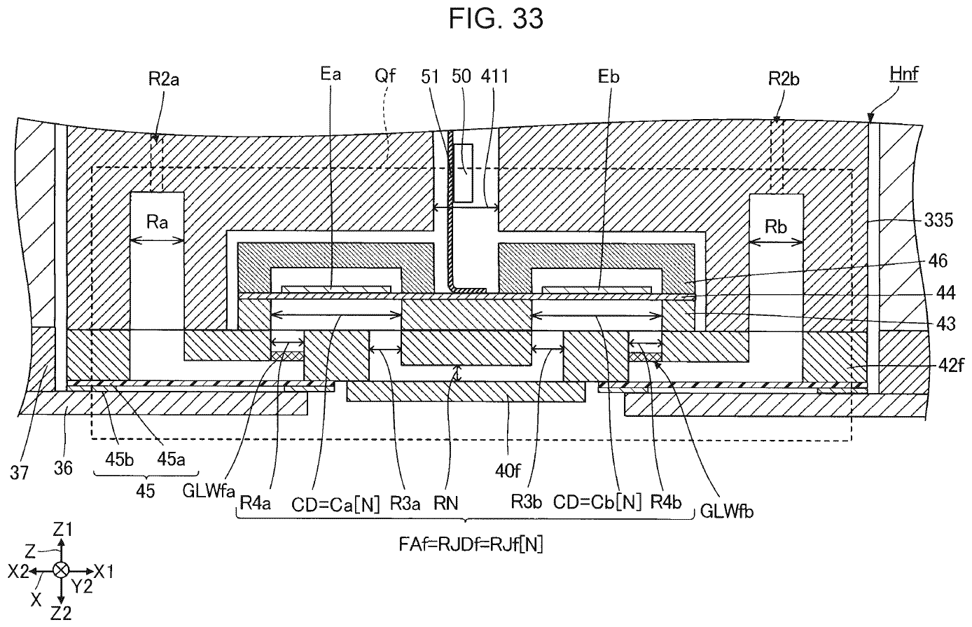

The ink supplied to the first liquid storage chamber Ra is discharged to the second liquid storage chamber Rb through N individual flow paths RJf. In the following description, in order to distinguish the N individual flow paths RJf, an individual flow path may be referred to as an individual flow path RJf[n1]. n1 is an integer of 1 or greater and N or less. Additionally, elements related to the individual flow path RJf[n1] may be described with [n1] added. In the first modification example, the N individual flow paths RJf include Nf individual flow paths RJf that directly contribute to forming an image on the medium PP, and one or more dummy individual flow paths RJDf used as detection spaces FA. The dummy individual flow path RJDf will be described below with reference to FIG. 33. The number Nf of nozzles Nzf is a number obtained by subtracting the number of dummy individual flow paths RJDf from the number N of individual flow paths RJf. Each of the N individual flow paths RJf is formed of the second communication flow path R4a, the pressure chamber Ca, the first communication flow path R3a, the nozzle flow path RN, the first communication flow path R3b, a pressure chamber Cb, and a second communication flow path R4b.

FIG. 33 is a view illustrating the dummy individual flow path RJDf in the first modification example. In FIG. 33, among the N individual flow paths RJf, an N-th individual flow path RJf[N] used as a detection space FAf in the first modification example, that is, as the dummy individual flow path RJDf, is shown. In the example of FIG. 33, the pressure chamber Ca[N] and the pressure chamber Cb[N] are the dummy pressure chamber CD, and a piezoelectric element Ea[N] and a piezoelectric element Eb[N] are the dummy piezoelectric element ED.

The dummy individual flow path RJDf is partitioned from the first liquid storage chamber Ra by a fragile bonding portion GLWfa and is partitioned from the second liquid storage chamber Rb by a fragile bonding portion GLWfb. The fragile bonding portion GLWfa is provided to cover the opening 37Ka, that is, at an end of the second communication flow path R4a in the Z2 direction. In addition, the fragile bonding portion GLWfb is provided to cover an opening 37Kb, that is, at an end of the second communication flow path R4b in the Z2 direction. In the following description, the fragile bonding portion GLWfa and the fragile bonding portion GLWfb may be referred to as a fragile bonding portion GLWf without distinction.

As understood from FIG. 33, the dummy individual flow path RJDf does not include the dummy nozzle NzD. Therefore, the dummy individual flow path RJDf is a sealed space. By the dummy individual flow path RJDf not including the dummy nozzle NzD, it is possible to prevent ink from being pushed from the dummy nozzle NzD into the dummy individual flow path RJDf even though the fragile bonding portion GLWf is not deteriorated. Accordingly, according to the first modification example, the dummy individual flow path RJDf can improve the accuracy of estimating the deterioration of the bonding portion GL57 as compared with an aspect in which the dummy nozzle NzD is provided.

In the first modification example, the dummy individual flow path RJDf includes two dummy pressure chambers CD, but may include only one dummy pressure chamber CD. In addition, in the first modification example, it is described that the dummy individual flow path RJDf does not include the dummy nozzle NzD, but the dummy individual flow path RJDf may include the dummy nozzle NzD.

### 6-2. Second Modification Example

In the first embodiment, a sign of ink leakage from the liquid ejecting head 30 is detected using the residual vibration information NEI, but the present disclosure is not limited thereto. For example, the ink jet printer 100 may detect, using an imaging device, whether a liquid surface of ink, that is, a meniscus, is formed at the dummy nozzle NzD. When a meniscus is formed at the dummy nozzle NzD, the ink jet printer 100 detects that there is a sign of ink leakage from the liquid ejecting head 30. Additionally, the ink jet printer 100 may detect, using an imaging device, whether or not ink is ejected from the dummy nozzle NzD when the drive signal Com is supplied to the dummy piezoelectric element ED. In a third modification example, a case where the dummy individual flow path RJDf includes the dummy nozzle NzD in the first modification example can also be applied. Further, in the third modification example, the second modification example may be applied, and a heating element may be used.

### 6-3. Third Modification Example

In the second embodiment and in the second modification example based on the second embodiment, whether or not ink is present in the detection space FAa is detected using the detection conductive wire 65 disposed in the detection space FAa, but the present disclosure is not limited thereto. For example, one of a bottom surface and an upper surface of the detection space FAa may include a light-emitting portion, and the other may include a light-receiving portion, and whether or not ink is present in the detection space FAa may be detected based on whether or not the light emitted from the light-emitting portion is received by the light-receiving portion. The ink in the third modification example is assumed to have light-shielding properties. The light-emitting portion includes a light-emitting element such as a light emitting diode (LED) that emits light in a natural light region. The light-receiving portion includes, for example, a light-receiving element such as a photodiode having light-receiving sensitivity to light in the natural light region.

### 6-4. Fourth Modification Example

In each of the aspects mentioned above, the liquid ejecting head 30 may include the detection space FA corresponding to each of two or more bonding portions GL. For example, the liquid ejecting head 30 may include the dummy individual flow path RJD, which is the detection space FA of the first embodiment, as the detection space FA for detecting a sign of ink leakage from the bonding portion GL in the head unit Hn, and the detection space FAa of the second embodiment, as the detection space FA for detecting a sign of ink leakage from the bonding portion GL in the flow path structure 33. The estimation section 73 in the fourth modification example estimates the degree of deterioration of the bonding portion GL in the head unit Hn and the degree of deterioration of the bonding portion GL in the flow path structure 33. The notification section 75 in the fourth modification example notifies the user U of a character string indicating a position of the liquid ejecting head 30 where there is a sign of ink leakage as the notification information CI. The character string indicating a position where there is a sign of ink leakage is, for example, when it is estimated that the bonding portion GL in the flow path structure 33 is deteriorated, the notification information CI indicating “There is a sign of ink leakage in the flow path structure”.

In addition, by providing the detection space FA corresponding to each of two or more bonding portions GL in the liquid ejecting head 30, the head manufacturer may replace the portion where there is a sign of ink leakage. For example, the detection space FA corresponding to each of the bonding portion GL in the flow path structure 33 in the liquid ejecting head 30 and the bonding portion GL in each head unit Hn is provided, and it is assumed that the notification section 75 notifies the user U that the bonding portion GL in one of the head units Hn is deteriorated. In this case, the head manufacturer can extend the lifetime of the liquid ejecting head 30 by replacing the head unit Hn in which deterioration of the bonding portion GL is detected.

### 6-5. Fifth Modification Example

In each of the aspects mentioned above, the control circuit 21 functions as the acquisition section 71, the estimation section 73, and the notification section 75, but may function as the acquisition section 71 and the estimation section 73 without functioning as the notification section 75. For example, when a service support staff member of the head manufacturer visits the printer manufacturer or the user U and executes the series of processes shown in FIG. 17, the control circuit 21 need not function as the notification section 75. The service support staff member provides appropriate support based on the estimation result estimated by the estimation section 73. For example, when the estimation result indicates that there is a sign of ink leakage in the bonding portion GL57, the service support staff member may propose replacement of the liquid ejecting head 30 to the user U.

What is claimed is:

1. A liquid ejecting head comprising:
a plurality of nozzles configured to eject liquid;
a first flow path member that defines a part of a flow path communicating with the plurality of nozzles;
a second flow path member that defines a part of the flow path;
a first bonding portion that liquid-tightly couples a part of the flow path of the first flow path member and a part of the flow path of the second flow path member; and
a second bonding portion that is a bonding portion defining an inner wall of the flow path, the second bonding portion defining a detection space that serves as a space for detecting a degree of deterioration of the first bonding portion and that is partitioned from the flow path.

2. The liquid ejecting head according to claim 1, wherein
an adhesive forming the second bonding portion and an adhesive forming the first bonding portion are of the same type.

3. The liquid ejecting head according to claim 2, wherein
a shortest distance from a portion of the second bonding portion that defines the flow path to a portion of the second bonding portion that defines the detection space is shorter than a shortest distance from a portion of the first bonding portion that defines the flow path to an end portion of the first bonding portion on a side opposite to the portion that defines the flow path.

4. The liquid ejecting head according to claim 1, wherein
a liquid resistance of the second bonding portion is lower than a liquid resistance of the first bonding portion.

5. The liquid ejecting head according to claim 1, wherein
a conductive wire for detecting the degree of deterioration of the first bonding portion is disposed in the detection space.

6. The liquid ejecting head according to claim 1, wherein
the flow path includes a plurality of individual flow paths respectively communicating with the plurality of nozzles, and a common liquid chamber coupled in common to the plurality of individual flow paths, and
the second bonding portion partitions at least a part of a dummy individual flow path from the common liquid chamber, as the detection space.

7. The liquid ejecting head according to claim 6, wherein
the liquid ejecting head forms an image by ejecting the liquid onto a medium,
a dummy piezoelectric element that does not directly contribute to forming the image is further provided, and
the dummy individual flow path includes a dummy pressure chamber inside which pressure is applied by the dummy piezoelectric element.

8. The liquid ejecting head according to claim 1, wherein
the detection space is a sealed space.

9. The liquid ejecting head according to claim 8, wherein
the detection space is defined by the second bonding portion closing an opening of a recessed portion provided in a bottom surface defining the flow path, and
the opening of the recessed portion is open in a direction opposite to a direction in which the nozzle is open.

10. The liquid ejecting head according to claim 8, wherein
as viewed in a lamination direction of the first flow path member and the second flow path member, a part of the flow path is surrounded by an annular bonding portion, and
as viewed in the lamination direction, a part of the annular bonding portion is formed by the first bonding portion, and a remaining portion of the annular bonding portion is formed by the second bonding portion.

11. The liquid ejecting head according to claim 8, wherein
a member defining a part of the detection space has light-transmitting properties.

12. The liquid ejecting head according to claim 8, wherein
the detection space is a bypass flow path that branches from a first coupling portion of the flow path and that merges with the flow path at a second coupling portion different from the first coupling portion of the flow path, and
the second bonding portion closes the first coupling portion and the second coupling portion.

13. A liquid ejecting apparatus comprising:
the liquid ejecting head according to claim 1;
an acquisition section that acquires information regarding presence or absence of liquid in the detection space; and
an estimation section that estimates the degree of deterioration of the first bonding portion based on the information acquired by the acquisition section.

14. The liquid ejecting apparatus according to claim 13, further comprising:
a notification section that issues a notification prompting replacement of the liquid ejecting head when the estimation section estimates that the first bonding portion is deteriorated.
